(19) United States
(12) Patent Application Publication
(10) Pub. No.: US 2013/0215866 A1
(43) Pub. Date: Aug. 22, 2013

(54) APPARATUS AND METHOD FOR TRANSMITTING POWER INFORMATION ABOUT COMPONENT CARRIER IN MULTIPLE COMPONENT CARRIER SYSTEM

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(21) Appl. No.: 13/883,525

(22) PCT Filed: Nov. 2, 2011
(86) PCT No.: PCT/KR2011/008287

§ 371 Date: May 3, 2013

(30) Foreign Application Priority Data
Nov. 5, 2010 (KR) 10-2010-0110071
Nov. 10, 2010 (KR) 10-2010-0111795
Nov. 11, 2010 (KR) 10-2010-0112348

(51) Int. Cl. H04W 52/04

(52) U.S. Cl. CPC H04W 52/04
USPC 370/329

(57) ABSTRACT

The present invention provides an apparatus and method of a mobile station transmitting power information in a multiple component carrier system. This specification discloses configuring a Type Indicator Field (TIF) to indicate whether a first type of a maximum transmission power and a second type of a maximum transmission power which are outputted for primary component carriers of a Primary Serving Cell (PSC) are identical with each other, configuring at least one power field on the basis of the TIF, and transmitting a Medium Access Control (MAC) message, including the TIF and the at least one power field, to a base station. According to the present invention, in a wireless system in which a component aggregation is used, a maximum transmission power report regarding a PSC within an MAC control element is not redundantly performed using a TIF.

### CROSS-REFERENCE TO RELATED APPLICATIONS

This application is the National Stage Entry of International Application No. PCT/KR2011/008287, filed on Nov. 2, 2011, and which claims priority to and the benefit of Korean Patent Application Nos. 10-2010-0110071, filed on Nov. 5, 2010, 10-2010-0111795, filed on Nov. 10, 2010, and 10-2010-0112348, filed on Nov. 11, 2010, all of which are incorporated herein by reference as if fully set forth herein.

### BACKGROUND

1. Field

The present invention relates to wireless communication and, more particularly, to an apparatus and method for transmitting power information about a component carrier in a is multiple component carrier system.

2. Discussion of the Background

As candidates of the next-generation wireless communication system, 3^{rd} Generation Partnership Project (3GPP) Long Term Evolution (LTE) and Institute of Electrical and Electronics Engineers (IEEE) 802.16m are being developed. The IEEE 802.16m standard involves the two aspects of the past continuation (i.e., an amendment to the existing IEEE 802.16e standard) and the future continuation (i.e., a standard for the next-generation IMT-Advanced system). Accordingly, the IEEE 802.16m standard is required to fulfill all advanced requirements for the IMT-Advanced system while maintaining compatibility with a Mobile WiMAX system in accordance with the IEEE 802.16e standard.

In genera, a wireless communication system uses one bandwidth for data transmission. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increasing transmission capacity, the bandwidth of the recent 3GPP LTE or 802.16m continues to be extended up to 20 MHz or higher. To increase the bandwidth may be considered as being essential so as to increase the transmission capacity, but to support a great bandwidth even though the required level of Quality of Service (QoS) is low may generate great power consumption.

In order to solve the problem, there has emerged a multi-component carrier system in which a component carrier having one bandwidth and the center frequency is defined and data is transmitted or received in a wide band through a plurality of component carriers. That is, a narrow band and a wide band are supported at the same time by using one or more component carriers. For example, if one component carrier corresponds to a bandwidth of 5 MHz, a maximum 20 MHz bandwidth can be supported by using four component carriers.

A method of a base station efficiently utilizing the resources of a mobile station is to use power information about the mobile station. A power control technique is an essential technique for minimizing interference factors and for reducing the battery consumption of a mobile station in order to efficiently distribute resources in a wireless communication. A mobile station may determine uplink transmission power on the basis of Transmit Power Control (TPC) allocated by a base station, a Modulation and Coding Scheme (MCS), and scheduling information about the bandwidth, etc.

As a multiple component carrier system is introduced, the uplink transmission power of component carriers has to be generally taken into consideration. Accordingly, the power control of a mobile station becomes more complicated. Such complexity may cause problems in terms of a maximum transmission power of a mobile station. In general, a mobile station must be operated by power lower than a maximum transmission power which is an allowable transmission power. If a base station performs scheduling requiring a transmission power higher than the maximum transmission power, a problem may be generated in which an actual uplink transmission power exceeds the maximum transmission power. This is because power control for multiple component carriers has not been clearly defined or information about an uplink transmission power has not been sufficiently shared between a mobile station and a base station.

### SUMMARY

An object of the present invention is to provide an apparatus and method for transmitting and receiving power information about a component carrier in a multiple component carrier system.

Another object of the present invention is to provide an apparatus and method for configuring power information about a component carrier in a multiple component carrier system.

Yet another object of the present invention is to provide an apparatus and method for configuring an MAC control element regarding a component carrier in a multiple component carrier system.

Still another object of the present invention is to provide an apparatus and method for interpreting an MAC control element regarding a component carrier in a multiple component carrier system.

Further yet another object of the present invention is to provide an apparatus and method for grouping and indicating component carriers having the same maximum transmission power in a multiple component carrier system.

Still yet another object of the present invention is to provide an apparatus and method for indicating a maximum transmission power for each transmission type in a multiple component carrier system.

Further yet another object of the present invention is to provide an apparatus and method for indicating the maximum number of same transmission powers in a multiple component carrier system.

According to an embodiment of the present invention, a method of a mobile station transmitting power information in a multiple component carrier system comprises calculating a maximum transmission power which can be outputted, for each of a plurality of component carriers, configuring a Cell Indicator Field (CIF) to indicate component carriers is having an identical maximum transmission power, configuring a first power field to indicate the identical maximum transmission power, generating a Medium Access Control (MAC) message, comprising the CIF and the first power field and transmitting the MAC message to a base station, wherein the MAC message comprises an MAC sub-header and an MAC control element, and the MAC sub-header comprises a Logical Channel Identifier (LCID) field to identify that the MAC control element is an MAC control element for a power report of one or more component carriers.

The MAC message may further comprise a second power field to indicate any one of a first type of a maximum transmission power when only a Physical Uplink Shared CHannel (PUSCH) is transmitted and a second type of a maximum transmission power when both a PUSCH and a Physical Uplink Control Channel (PUCCH) are transmitted.

The MAC message may further comprise a third power field to indicate a maximum transmission power for component carriers having a maximum transmission power different from the identical maximum transmission power which the first power field indicates.

The MAC control element may be an integer multiple of an octet having an 8-bit length.

The MAC control element may comprise the CIF and the first power field.

According to another embodiment of the present invention, a mobile station for transmitting power information in a multiple component carrier system comprises a power calculation unit for calculating a maximum transmission power which can be outputted for each of a plurality of component carriers, an Identical Power Cell Group (IPCG) determination unit for determining a group having component carriers an identical maximum transmission power, a power information generation unit for generating a Medium Access Control (MAC) message, is including a Cell Indicator Field (CIF) to indicate the component carriers included in the group and a first power field to indicate the identical maximum transmission power and an uplink information transmission unit for transmitting the MAC message to a base station, wherein the power information generation unit generates the MAC message comprising a MAC sub-header and a MAC control element, and the MAC sub-header comprises a Logical Channel Identifier (LCID) field to identify that the MAC control element is an MAC control element for a power report of one or more component carriers.

According to another embodiment of the present invention, a method of a base station receiving power information in a multiple component carrier system comprises receiving a Medium Access Control (MAC) message, comprising a Cell Indicator Field (CIF) to indicate component carriers having an identical maximum transmission power and a first power field to indicate the identical maximum transmission power, from a mobile station, checking an Identical Power Cell Group (IPCG) based on the CIF and obtaining a maximum transmission power value for each of the component carriers based on the IPCG and the first power field and performing uplink scheduling based on the maximum transmission power value for each of the component carriers, wherein the MAC message comprises a MAC sub-header and a MAC control element, and the MAC sub-header comprises a Logical Channel Identifier (LCID) field to identify that the MAC control element is an MAC control element for a power report, of one or more component carriers.

According to another embodiment of the present invention, a base station for receiving power information in a multiple component carrier system comprises an uplink information reception unit for receiving a Medium Access Control (MAC) message, comprising a Cell Indicator Field (CIF) to indicate component carriers having an identical maximum is transmission power and a first power field to indicate the identical maximum transmission power, from a mobile station, a power information analysis unit for checking an Identical Power Cell Group (IPCG) based on the CIF, a power acquisition unit for obtaining a maximum transmission power value for each of the component carriers based on the IPCG and the first power field and a scheduling unit for performing uplink scheduling based on the maximum transmission power value for each of the component carriers, wherein the MAC message comprises a MAC sub-header and a MAC control element, and the MAC sub-header comprises a Logical Channel Identifier (LCID) field to identify that the MAC control element is an MAC control element for a power report, of one or more component carriers.

In accordance with the present invention, in a wireless system in which a component aggregation is used, a maximum transmission power report on a Primary Serving Cell (PSC) within an MAC control element is prevented from being redundantly performed using a TIF. Accordingly, there is an advantage in that the consumption of uplink resources can be reduced.

Furthermore, according to the present invention, in a wireless system in which a component aggregation is used, a P_{cmax} value transmitted for efficient uplink power control can be configured without a waste of resources on an MAC control element. Accordingly, there are advantages in that reliability of an MAC message can be improved and a waste of uplink to resources used for control can be reduced because a waste of resources within an MAC control element is prevented.

### BRIEF DESCRIPTION OF THE DRAWINGS

FIG. 1 is shows a wireless communication system;

FIG. 2 is an explanatory diagram illustrating an intra-band contiguous carrier aggregation;

FIG. 3 is an explanatory diagram illustrating an intra-band non-contiguous carrier aggregation;

FIG. 4 is an explanatory diagram illustrating an inter-band carrier aggregation;

FIG. 5 shows a linkage between a DL CC (downlink component carrier) and a UL CC (uplink component carrier) in a multiple carrier system;

FIG. 6 is a graph showing an example of power headroom to which the present invention is applied in the time-frequency axis;

FIG. 7 is a conceptual diagram illustrating the influence of uplink scheduling of a base station on the transmission power of a mobile station in a wireless communication system;

FIG. 8 is an explanatory diagram illustrating the power adjustment amount and the maximum transmission power in a multiple component carrier system according to an example of the present invention;

FIG. 9 is a block diagram showing the structure of an MAC PDU (MAC Protocol Data Unit) for a power report according to an example of the present invention;

FIG. 10 is a block diagram showing the structure of the MAC PDU for a power report according to another example of the present invention;

FIG. 11 is an explanatory diagram illustrating an example of a method of selecting a Power Report Cell Group (PRCG);

FIG. 12 is an explanatory diagram illustrating another example of the method of selecting a PRCG;

FIG. 13 is an explanatory diagram illustrating yet another example of the method is of selecting the PRCG;

FIG. 14 shows the structure of an MAC control element for a power report according to an example of the present invention;

FIG. 15 shows the structure of an MAC control element for a power report according to another example of the present invention;

FIG. 16 shows the structure of an MAC control element for a power report according to yet another example of the present invention;

FIG. 17 shows the structure of an the MAC control element for a power report according to yet another example of the present invention;

FIG. 18 shows an example in which the MAC control element for a power report according to FIG. 17 is utilized;

FIG. 19 shows another example in which the MAC control element for a power report according to FIG. 17 is utilized;

FIG. 20 shows yet another example in which the MAC control element for a power report according to FIG. 17 is utilized;

FIG. 21 shows the structure of the MAC control element for a power report according to yet another example of the present invention;

FIG. 22 shows the structure of an MAC control element for a power report according to further yet another example of the present invention;

FIG. 23 shows the structure of an MAC control element for a power report according to still yet another example of the present invention;

FIG. 24 shows the structure of an MAC control element for a power report according to further yet another example of the present invention;

FIG. 25 shows an example in which the MAC control element for a power report according to FIG. 24 is utilized;

FIG. 26 shows another example in which the MAC control element for a power report according to FIG. 24 is utilized;

FIG. 27 shows the structure of an MAC control element for a power report according to still yet another example of the present invention;

FIG. 28 shows the structure of an MAC control element for a power report according to further yet another example of the present invention;

FIG. 29 shows the structure of an MAC control element for a power report according to further yet another example of the present invention;

FIG. 30 shows the structure of an MAC control element for a power report according to still yet another example of the present invention;

FIG. 31 shows the structure of an MAC control element for a power report according to still yet another example of the present invention;

FIG. 32 shows the structures of MAC control elements for a power report according to still yet another example of the present invention;

FIG. 33 shows the structures of MAC control elements for a power report according to further yet another example of the present invention;

FIG. 34 shows the structures of MAC control elements for a power report according to still yet another example of the present invention;

FIG. 35 shows the structures of MAC control elements for a power report according to still yet another example of the present invention;

FIG. 36 shows an example in which the MAC control element for a power report is according to FIG. 35 is utilized;

FIG. 37 shows another example in which the MAC control element for a power report according to FIG. 35 is utilized;

FIG. 38 shows yet another example in which the MAC control element for a power report according to FIG. 35 is utilized;

FIG. 39 shows the structure of an MAC control element for a power report according to still yet another example of the present invention;

FIG. 40 shows the structures of MAC control elements for a power report according to still yet another example of the present invention;

FIG. 41 shows the structures of MAC control elements for a power report according to yet another example of the present invention;

FIG. 42 shows the structures of MAC control elements for a power report according to still yet another example of the present invention;

FIG. 43 is a flowchart illustrating a method of transmitting power information according to an example of the present invention;

FIG. 44 is a flowchart illustrating a method of transmitting power information according to an example of the present invention;

FIG. 45 is a flowchart illustrating a method of a mobile station transmitting power information according to an example of the present invention;

FIG. 46 is a flowchart illustrating a method of a base station receiving power information according to an example of the present invention;

FIG. 47 is a flowchart illustrating a method of a mobile station transmitting power information according to another example of the present invention;

FIG. 48 is a flowchart illustrating a method of a base station receiving power information according to another example of the present invention;

FIG. 49 is a diagram showing a flowchart of determining a format in which power information is transmitted by taking the simultaneous transmission of a PUCCH and a PUSCH into consideration according to an example of the present invention;

FIG. 50 is a flowchart illustrating a method of a mobile station transmitting power information according to yet another example of the present invention;

FIG. 51 is a flowchart illustrating a method of a base station receiving power information according to yet another example of the present invention; and

FIG. 52 is a block diagram of a mobile station transmitting power information and of a base station receiving the power information according to an example of the present invention.

### DETAILED DESCRIPTION OF THE ILLUSTRATED EMBODIMENTS

Hereinafter, in this specification, some embodiments of the present invention will be described in detail with reference to some exemplary drawings. It is to be noted that in assigning reference numerals to respective elements in the drawings, the same reference numerals designate the same elements although the elements are shown in different drawings. Furthermore, in describing the present invention, a detailed description of the known functions and constructions will be omitted if it is deemed to make the gist of the present invention unnecessarily vague.

Furthermore, in describing the elements of this specification, terms, such as the first, second, A, B, a, and b, may be used. The terms, however, are used to only distinguish one is element from the other element, but the essence, order, and sequence of the elements are not limited by the terms. Furthermore, if one element is described to be “connected”, “coupled”, or “jointed” to the other element, the one element may be directly connected (or coupled or jointed) to the other element, but it should be understood that a third element may be “connected”, “coupled”, or “jointed” between the two elements.

Furthermore, in this specification, a wireless communication network is chiefly described. Tasks performed in the wireless communication network may be performed in a process of a system (for example, a base station), managing the wireless communication network, controlling the network and transmitting data or the tasks may be performed by a mobile station coupled to the network.

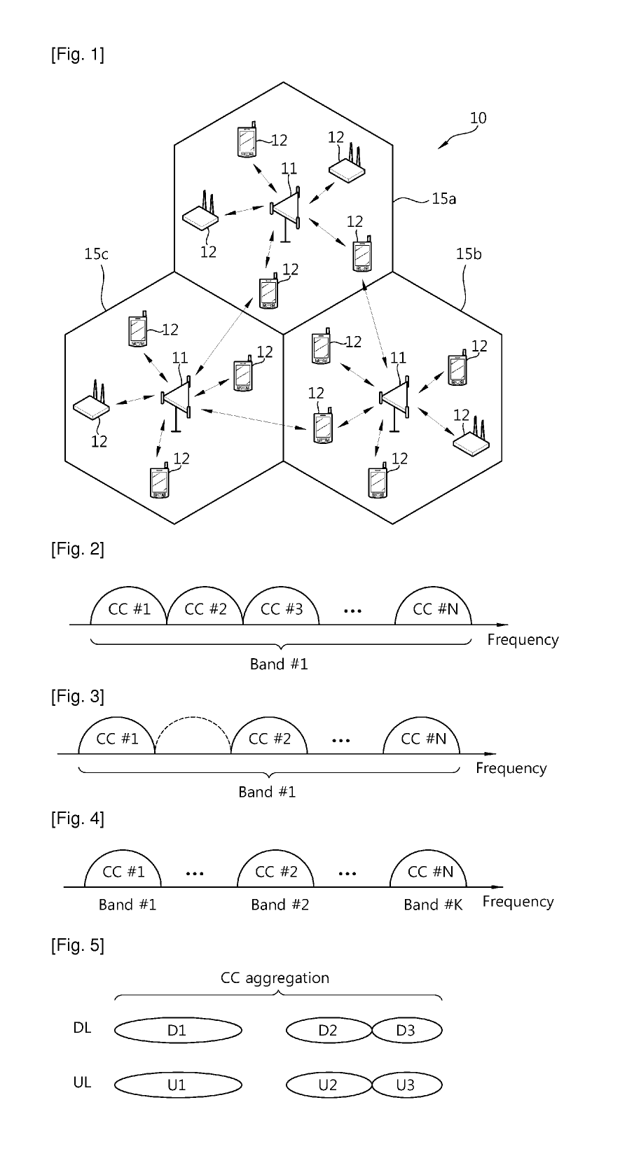

FIG. 1 shows a wireless communication system.

Referring to FIG. 1, the wireless communication systems 10 are widely deployed in order to provide a variety of communication services, such as voice and packet data.

The wireless communication system 10 includes one or more Base Stations (BS) 11. The BSs 11 provide communication services to specific geographical areas (typically called cells) 15a, 15b, and 15c. The cell may be classified into a plurality of areas (called sectors).

A Mobile Stations (MS) 12 may be fixed or mobile and may also be called another terminology, such as UE (User Equipment), an MT (Mobile Terminal), a UT (User Terminal), an SS (Subscriber Station), a wireless device, a PDA (Personal Digital Assistant), a wireless modem, or a handheld device.

The BS 11 refers to a fixed station communicating with the MSs 12, and it may also be called another terminology, such as eNodeB (evolved NodeB: eNB), a BTS (Base Transceiver System), or an access point. The cell should be interpreted as a comprehensive is meaning indicating some area covered by the BS 11. The cell has a meaning to cover various coverage areas, such as a mega cell, a macro cell, a micro cell, a pico cell, and a femto cell.

Hereinafter, downlink (DL) refers to communication from the BS 11 to the MS 12, and uplink (UL) refers to communication from the MS 12 to the BS 11. In this case, in downlink, a transmitter may be part of the BS 11, and a receiver may be part of the MS 12.

Furthermore, in uplink, a transmitter may be part of the MS 12, and a receiver may be part of the BS 11.

There is no limitation on multiple access schemes applied to a wireless communication system. A variety of multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA, may be used. In uplink transmission and downlink transmission, a TDD (Time Division Duplex) scheme in which the transmission is performed using different times may be used or an FDD (Frequency Division Duplex) scheme in which the transmission is performed using different frequencies may be used.

The layers of a radio interface protocol between a mobile station and a network may be classified into a first layer L1, a second layer L2, and a third layer L3 on the basis of three lower layers of an Open System Interconnection (OSI) which has been widely known in the communication systems.

A physical layer (i.e., the first layer) is connected to a higher Medium Access Control (MAC) layer through a transport channel. Data between the MAC layer and the physical layer is moved through the transport channel. Furthermore, data between different is physical layer (i.e., the physical layers on the transmission side and on the reception side) is moved through a physical channel. There are some control channels used in the physical layer. A Physical Downlink Control Channel (PDCCH) through which physical control information is transmitted informs a mobile station of the resource allocation of a PCH (paging channel) and a downlink shared channel (DL-SCH) and of Hybrid Automatic Repeat Request (HARQ) information related to the DL-SCH. The PDCCH may carry an uplink grant, informing a mobile station of the resource allocation of uplink transmission. A Physical Control Format Indicator Channel (PCFICH) is used to inform a mobile station of the number of OFDM symbols used in the PDCCHs and is transmitted for every frame. A Physical Hybrid ARQ Indicator Channel (PHICH) carries HARQ ACK/NAK signals in response to uplink transmission. A Physical Uplink Control Channel (PUCCH) carries the HARQ ACK/NAK signals for downlink transmission, a scheduling request, and uplink control information, such as Channel Quality Information (CQI). A Physical Uplink Shared Channel (PUSCH) carries a UL-SCH (uplink shared channel).

A situation in which a mobile station transmits the PUCCH or the PUSCH is described below.

A mobile station configures a PUCCH for one or more pieces of information about CQI, a PMI (Precoding Matrix Index) selected on the basis of measured space channel information, and an RI (Rank Indicator) and periodically transmits the configured PUCCH to a base station. Furthermore, the mobile station has to transmit information about ACK/NACK (Acknowledgement/non-Acknowledgement) for downlink data to a base station after a certain number of subframes after receiving the downlink data. For example, if downlink data is received in an n^{th} subframe, the mobile station transmits a PUCCH, composed of ACK/NACK is information about the downlink data, in an (n+4)^{th} subframe. If all pieces of ACK/NACK information cannot be transmitted on a PUCCH allocated by a base station or if a PUCCH on which ACK/NACK information can be transmitted is not allocated by a base station, a mobile station may carry the ACK/NACK information on a PUSCH.

A radio data link layer (i.e., the second layer) includes an MAC layer, an RLC layer, and a PDCP layer. The MAC layer is a layer responsible for mapping between a logical channel and a transport channel. The MAC layer selects a proper transport channel suitable for sending data received from the RLC layer and adds necessary control information to the header of an MAC PDU (Protocol Data Unit). The RLC layer is placed over the MAC layer and configured to support reliable data transmission. Furthermore, the RLC layer segments and concatenates RLC SDUs (Service Data Units) received from a higher layer in order to configure data having a size suitable for a radio section. The RLC layer of a receiver supports a data reassembly function for recovering original RLC SDUs from received RLC PDUs. The PDCP layer is used only in a packet exchange region, and it can compress and send the header of an IP packet in order to increase the transmission efficiency of packet data in a radio channel.

An RRC layer (i.e., the third layer) functions to control a lower layer and also to exchange pieces of radio resource control information between a mobile station and a network. A variety of RRC states, such as an idle mode and an RRC connected mode, are defined according to the communication state of a mobile station. A mobile station may transfer between the RRC states, if necessary. Various procedures related to the management of radio resources, such as system information broadcasting, an RRC access management procedure, a multiple component carrier configuration procedure, a radio bearer control procedure, a security procedure, a measurement procedure, and a mobility management procedure (handover), are is defined in the RRC layer.

A carrier aggregation (CA) supports a plurality of carriers. The carrier aggregation is also called a spectrum aggregation or a bandwidth aggregation. An individual unit carrier aggregated by the carrier aggregation is called a Component Carrier (CC). Each CC is defined by the bandwidth and the center frequency. The carrier aggregation is introduced to support an increased throughput, prevent an increase of the costs due to the introduction of wideband RF (radio frequency) devices, and guarantee compatibility with the existing system. For example, if five CCs are allocated as the granularity of a carrier unit having a 5 MHz bandwidth, a maximum bandwidth of 20 MHz can be supported.

CCs may be divided into a primary CC (hereinafter referred to as a PCC) and a secondary CC (hereinafter referred to as an SCC) according to whether they have been activated. The PCC is a carrier that is always being activated, and the SCC is a carrier that is activated or deactivated according to a specific condition. The term ‘activation’ means that the transmission or reception of traffic data is being performed or is in a standby state. The term ‘deactivation’ means that the transmission or reception of traffic data is impossible, but measurement or the transmission/reception of minimum information is possible. A mobile station may use only one PCC and one or more SCCs along with a PCC. A base station may allocate the PCC or the SCC or both to a mobile station.

The carrier aggregation may be classified into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

First, referring to FIG. 2, the intra-band contiguous carrier aggregation is formed between continuous CCs in the same band. For example, aggregated CCs, that is, a CC#1, a CC#2, a CC#3 to a CC #N are contiguous to each other.

Referring to FIG. 3, the intra-band non-contiguous carrier aggregation is formed between discontinuous CCs. For example, aggregated CCs, that is, a CC#1 and a CC#2 are spaced apart from each other by a specific frequency.

Referring to FIG. 4, the inter-band carrier aggregation is of a type in which, if a plurality of CCs exists, one or more of the CCs are aggregated on different frequency bands.

For example, an aggregated CC, that is, a CC #1 exists in a band #1, and an aggregated CC, that is, a CC #2 exists in a band #2.

The number of carriers aggregated in downlink and the number of carriers aggregated in uplink may be differently set. A case where the number of DL CCs is identical with the number of UL CCs is called a symmetric aggregation, and a case where the number of DL CCs is different from the number of UL CCs is called an asymmetric aggregation.

Furthermore, CCs may have different sizes (i.e., bandwidths). For example, assuming that 5 CCs are used to configure a 70 MHz band, the configuration of the 70 MHz band may be a 5 MHz CC (carrier #0)+a 20 MHz CC (carrier #1)+a 20 MHz CC (carrier #2)+a 20 MHz CC (carrier #3)+a 5 MHz CC (carrier #4).

A multiple carrier system hereinafter refers to a system supporting the carrier aggregation. In the multiple carrier system, the contiguous carrier aggregation or the non-contiguous carrier aggregation or both may be used. Furthermore, either the symmetric aggregation or the asymmetric aggregation may be used.

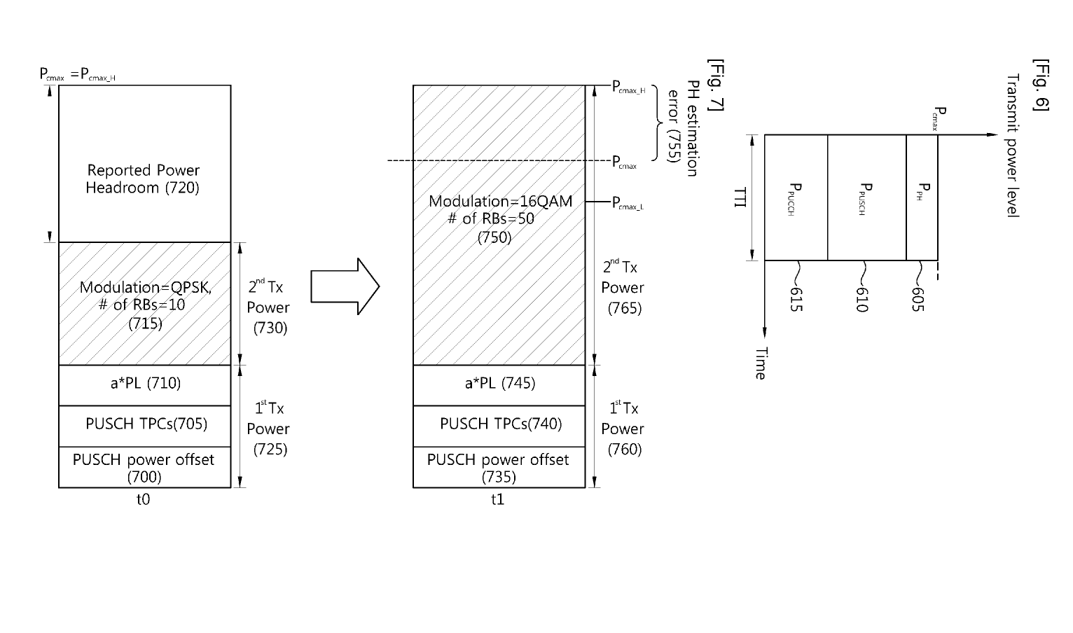

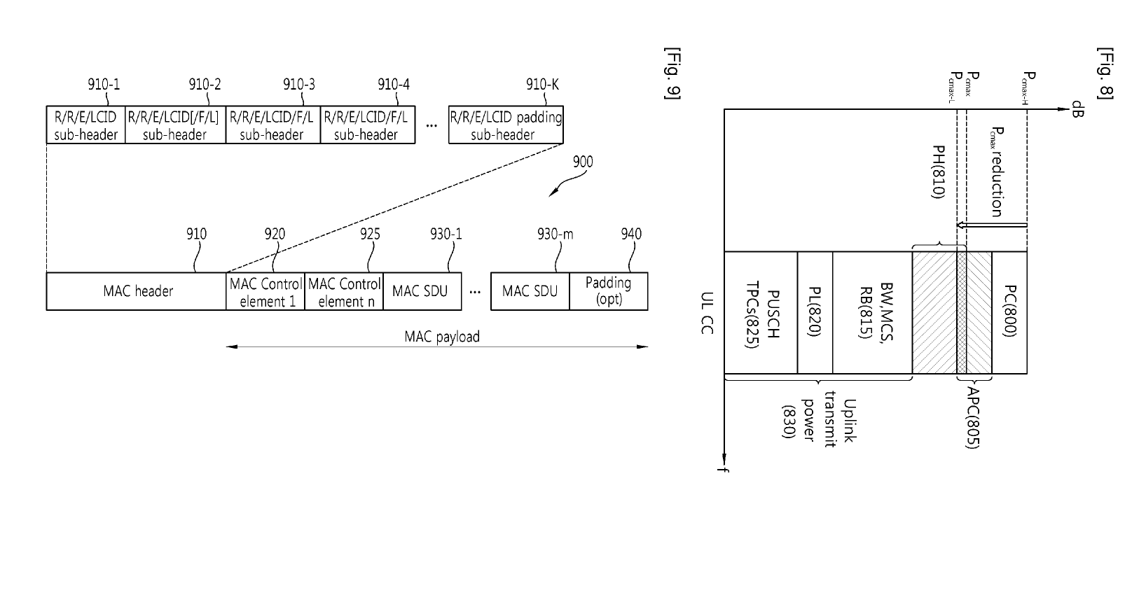

FIG. 5 shows a linkage between a DL CC (downlink component carrier) and a UL CC (uplink component carrier) in a multiple carrier system.

Referring to FIG. 5, in downlink, Downlink Component Carriers (hereinafter is referred to as ‘DL CC’) D1, D2, and D3 are aggregated. In uplink, Uplink Component Carriers (hereinafter referred to as ‘UL CC’) U1, U2, and U3 are aggregated. Here, Di is the index of a DL CC, and Ui is the index of a UL CC (where i=1, 2, 3). At least one DL CC is a PCC, and the remaining CCs are SCCs. Likewise, at least one UL CC is a PCC, and the remaining CCs are SCCs. For example, D1 and U1 may be PCCs, and D2, U2, D3, and U3 may be SCCs.

In an FDD system, a DL CC and a UL CC are linked to each other in a one-to-one manner. Each of pairs of D1 and U1, D2 and U2, and D3 and U3 is linked to each other in a one-to-one manner. A mobile station sets up pieces of linkage between the DL CCs and the UL CCs on the basis of system information transmitted on a logical channel BCCH or a UE-dedicated RRC message transmitted on a DCCH. Each of the pieces of linkage may be set up in a cell-specific way or a UE-specific way.

Only the 1:1 linkage between the DL CC and the UL CC has been illustrated in FIG. 5, but a 1:n or n:1 linkage may also be set up. Furthermore, the index of a component carrier does not comply with the sequence of the component carrier or the position of the frequency band of the component carrier.

Hereinafter, power headroom (PH) is described.

Power headroom means surplus power that may be additionally used by a mobile station for uplink transmission other than power which is now being used. For example, it is assumed that a mobile station has maximum transmission power of 10 W (i.e., uplink transmission power of an allowable range). It is also assumed that the mobile station is now using power of 9 W in the frequency band of 10 MHz. In this case, power headroom is 1 W because the mobile station can additionally use power of 1 W.

If a base station allocates a frequency band of 20 MHz to a mobile station, power is of 9 W×2=18 W is required. If the frequency band of 20 MHz is allocated to the mobile station, however, the mobile station may not use the entire frequency band because the mobile station has the maximum power of 10 W, or the base station may not properly receive signals from the mobile station owing to the shortage of power. In order to solve the problems, the mobile station may report the power headroom of 1 W to the base station so that the base station can perform scheduling within the range of the power headroom. This report is called a Power Headroom Report (PHR).

A periodic PHR method may be used because the power headroom is frequently changed. According to the periodic PHR method, when a periodic timer expires, a mobile station triggers the PHR. After reporting power headroom, the mobile station drives the periodic timer again.

Furthermore, when a Path Loss (PL) estimate measured by a mobile station exceeds a certain reference value, the PHR may be triggered. The PL estimate is measured by a mobile station on the basis of Reference Symbol Received Power (RSRP).

Power headroom P_{PH} is defined as a difference between a maximum transmission power P_{cmax}, configured in a mobile station, and power P_{estimated} estimated in regard to uplink estimated transmission as in Equation 1 and is represented by dB.

P_{PH}=P_{cmax}−P_{estimated} [dB] Equation 1

The power headroom P_{PH} may also be called the remaining power or surplus power. That is, the remainder, obtained by subtracting the estimated power P_{estimated} (i.e., the sum of transmission powers being used by CCs) from a mobile station's maximum transmission power configured by a base station, becomes the P_{PH} value.

For example, the estimated power P_{estimated} is equal to power P_{PUSCH} estimated in regard to the transmission of a Physical Uplink Shared Channel (hereinafter referred to as a PUSCH). In this case, the power headroom P_{PH} may be calculated using Equation 2. Equation 2 shows an example in which only the PUSCH is transmitted in uplink, which is called a type 1. Power headroom according to the type 1 is called type 1 power headroom.

P_{PH}−P_{cmax}−P_{PUSCH} [dB] Equation 2

For another example, the estimated power P_{estimated} is equal to the sum of power P_{PUSCH} estimated in regard to the transmission of a PUSCH and power P_{PUCCH} estimated in regard to the transmission of a Physical Uplink Control Channel (hereinafter referred to as a PUCCH). In this case, the power headroom P_{PH} may be calculated using Equation 3. Equation 3 shows an example in which the PUSCH and the PUCCH are transmitted at the same time, which is called a type 2. Power headroom according to the type 2 is called type 2 power headroom.

P_{PH}=P_{cmax}−P_{PUCCH}−P_{PUSCH} [dB] Equation 3

If the power headroom according to Equation 3 is represented by a graph in the time-frequency axis, it results in FIG. 6. FIG. 6 shows power headroom for one CC.

Referring to FIG. 6, the maximum transmission power P_{cmax} configured in a mobile station consists of P_{PH} 605, P_{PUSCH} 610, and P_{PUCCH} 615. That is, the remaining power obtained by subtracting P_{PUSCH} 610 and P_{PUCCH} 615 have been subtracted from P_{cmax} is defined as P_{PH} 605. Each power is calculated for every Transmission Time Interval (TTI).

A PSC (primary serving cell) is a unique serving cell which has a UL PCC on is which the PUCCH can be transmitted. Accordingly, in a secondary serving cell, power headroom is defined as in Equation 2 because the PUCCH cannot be transmitted, and a parameter and an operation for a method of reporting power headroom defined by Equation 3 are not defined.

On the other hand, in a PSC, an operation and parameters for the method of reporting power headroom defined by Equation 3 may be defined. If a mobile station has to receive an uplink grant from a base station, transmit the PUSCH in a PSC, and simultaneously transmit the PUCCH in the same subframe according to a predetermined rule, the mobile station calculates both the power headroom according to Equation 2 and the power headroom according to Equation 3 when a Power Headroom Report (PHR) is triggered and transmits the calculated result to a base station.

FIG. 7 is a conceptual diagram illustrating the influence of the uplink scheduling of a base station on the transmission power of a mobile station in a wireless communication system.

Referring to FIG. 7, a mobile station receives an uplink grant, permitting uplink data transmission, from a base station through a PDCCH at time (or subframe) t0. Accordingly, the mobile station has to calculate the amount of transmission power in response to the uplink grant at the time t0.

First, at the time t0, the mobile station calculates a first transmission (Tx) power 725 by taking ‘a value’ (received from the base station) (i.e., weight) into account in a PUSCH power offset (700) value received from the base station, a transmission power control (TPC, 705) value, and a path loss (PL) 710 between the base station and the mobile station. The first transmission power 725 is based on parameters, chiefly influenced by a path environment is between the base station and the mobile station, and parameters determined by the policy of a network. In addition, the mobile station calculates a second transmission (Tx) power 730 by taking a scheduling parameter 715, indicating a QPSK modulation scheme included in the uplink grant and the allocation of ten resource blocks. The second transmission power 730 is a transmission power which is changed through the uplink scheduling of the base station.

Accordingly, the mobile station may calculate a final uplink transmission power by summing the first transmission power 725 and the second transmission power 730. Here, the final uplink transmission power cannot exceed the maximum transmission power P_{cmax} configured in a mobile station. In the example of FIG. 7, uplink information complying with the set parameters can be transmitted at the time t0 because the final transmission power is smaller than the value P_{cmax}. Furthermore, there is power headroom 720 which is surplus for a transmission power that may be additionally configured. The power headroom 720 is transmitted from the mobile station to the base station according to rules defined in a wireless communication system.

At a time t1, the base station changes the scheduling parameter 715 into a scheduling parameter 750, indicating a 16QAM modulation scheme and the allocation of 50 resource blocks, on the basis of the information of the power headroom 720 by taking the transmission power that may be additionally allocated to the mobile station. The mobile station reconfigures a second transmission power 765 according to the scheduling parameter 750. The first transmission power 760 at the time t1 is determined by taking ‘a value’ (received from the base station) (i.e., weight) into account in a PUSCH power offset (735) value, a transmission power control (740) value, and a PL 745 between the base station and the mobile station. Here, it is assumed that the first transmission power 760 at the time t1 is equal to the first transmission is power 725 at the time t0.

At the time t1, P_{cmax} is changed to be close P_{cmax-L}, whereas the sum of the second transmission power 765 and the first transmission power 760 required by the scheduling parameter 750 exceeds P That is, there is a PH estimation value error 755 corresponding to ‘P_{cmax-H}−P_{cmax}’. If scheduling for uplink resources is performed on the basis of only PH information as described above, performance is degraded because a mobile station cannot configure an uplink transmission power expected by a base station. If a component carrier aggregation method is used, the PH estimation value error 755 becomes further great.

In either a single component carrier system or a multiple component carrier system, a maximum transmission power configured in a mobile station is influenced by the power adjustment of the mobile station. The term ‘power adjustment means that a maximum uplink transmission power configured in a mobile station is reduced within a permitted range, and the power adjustment may also be called a Maximum Power Reduction (MPR). Furthermore, the amount of power reduced by the power adjustment is called a power adjustment amount. The reason why a maximum transmission power configured in a mobile station is reduced is described below. There is a case where the maximum transmission power must be restricted according to a type of a signal that has to be now transmitted on the basis of the hardware configuration (in particular, radio frequency (RF)) within a mobile station.

The range of a maximum transmission power in which power adjustment is taken into account is as follows.

P_{cmax-L}≦P_{cmax}≦P_{cmax-H} Equation 4

In Equation 4, P_{cmax} is a maximum transmission power configured in a mobile station, P_{cmax-L} is a minimum value of P_{cmax}, and P_{cmax-H} is a maximum value of P_{cmax}. More particularly, P_{cmax-L} and P_{cmax-H} are calculated according to Equations below.

P_{cmax-L}=MIN[P_{Emax}−ΔT_{C},P_{powerclass}−PA−APA−ΔT_{C}] Equation 5

P_{cmax-H}=MIN[P_{Emax},P_{powerclass}] Equation 6

In Equations 5 and 6, MIN[a,b] is a smaller one of values a and b, and P_{Emax} is a maximum power determined by the RRC signaling of a base station. ΔT_{C} is the amount of power which is used when there is uplink transmission at the edge of a frequency band, and it has 1.5 dB or 0 dB according to the bandwidth. P_{powerclass} is a power value according to several power classes defined in order to support various specifications of a mobile station in a system. In general, an LTE system supports a power class 3. P_{powerclass} according to the power class 3 is 23 dB. PA is a power adjustment amount, and APA (Additional Power Adjustment) is an additional power adjustment amount signaled by a base station.

The power adjustment may be set to a specific range or may be set to a specific constant. The power adjustment may be defined for every mobile station or may be defined for every CC. The power adjustment may be set to a range or a constant within each CC. Furthermore, the power adjustment may be set to a range or a constant according to whether the PUSCH resource allocation of each CC is contiguous or non-contiguous. Furthermore, the power adjustment may be set to a range or a constant according to whether a PUCCH exists or not.

FIG. 8 is an explanatory diagram illustrating a power adjustment amount and a maximum transmission power in a multiple component carrier system according to an example of the present invention. It is assumed that only one UL CC is allocated to a mobile station, for the sake of convenience.

Referring to FIG. 8, assuming that ΔT_{C}=0, the maximum value P_{cmax-H} of the maximum transmission power P_{cmax} may be 23 dB corresponding to the power class 3. The minimum value P_{cmax-L} of the maximum transmission power P_{cmax} is a value in which a power adjustment (PA) amount 800 and an additional power adjustment (APA) amount 805 have been subtracted from the maximum value P_{cmax-H}. That is, a mobile station reduces the minimum value P_{cmax-L} of the maximum transmission power P_{cmax} using the power adjustment (PA) amount 800 and the additional power adjustment (APA) amount 805. The maximum transmission power P_{cmax} is determined between the maximum value P_{cmax-H} and the minimum value P_{cmax-L}.

Meanwhile, the uplink transmission power 830 is the sum of power 815 determined by a bandwidth BW, an MCS, and an RB, a pathloss (PL) 820, and PUSCH transmission power controls (TPCs) 825. The PH 810 is a value in which the uplink transmission power 830 has been subtracted from the maximum transmission power P_{cmax}.

Only one UL CC has been described with reference to FIG. 8. If a plurality of UL CCs has been allocated, however, the maximum transmission power may be determined for every mobile station not for every UL CC. The maximum transmission power for each mobile station may be calculated as the sum of maximum transmission powers for all UL CCs.

In calculating the maximum transmission power, the P_{Emax}, the ΔT_{C}, the P_{powerclass}, and the additional power adjustment (APA) amount correspond to pieces of information that are known to a base station or that may be known to a base station. However, since the power is adjustment (PA) amount may be variable, the maximum transmission power of a mobile station is also varied accordingly. When a mobile station reports power headroom to a base station, the base station may approximately estimate the maximum transmission power on the basis of the power headroom. The base station performs uncertain uplink scheduling within the estimated maximum transmission power. Accordingly, the base station may perform scheduling with a modulation scheme, a channel bandwidth, and the number of RBs which require transmission power higher than the maximum transmission power for the mobile station. This problem may become more severe in a multiple component carrier system. Accordingly, the mobile station needs to inform the base station of the amount or range of a maximum transmission power for every CC. Hereinafter, the maximum transmission power for every CC is called a carrier maximum transmission power P_{cmax,c}.

Meanwhile, in a multiple component carrier environment, scheduling cases of various CCs may exist. Furthermore, P_{cmax,c} information about each of the cases needs to be transmitted. If the amount of the P_{cmax,c} information is too great, however, a problem may occur in limited uplink resources. There may be a case where the carrier maximum transmission power P_{cmax,c} is the same for several CCs.

For example, the carrier maximum transmission power P_{cmax,c} may be the same between a plurality of CCs according to a scheduling configuration. There is a high possibility to that the P_{cmax,c} information may have the same value for CCs in relation to the same scheduling configuration because it is a value related to the characteristic of a radio frequency (RF). Here, the term ‘scheduling configuration’ refers to a configuration, including a CC configuration scheduled to a mobile station, an RB (resource block) configuration, and an MCS (modulation and coding scheme) configuration, and so on.

For another example, if all configured CCs are formed into one RF, the P_{cmax,c} value may be the same for a plurality of CCs.

For yet another example, the carrier maximum transmission power P_{cmax,c} of the type 1 and the carrier maximum transmission power P_{cmax,c} of the type 2 may have the same value according to a type of allocation.

In all the cases, to repeatedly transmit the same P_{cmax,c} value for a plurality of CCs is a waste of resources.

This problem may be solved using two kinds of methods. The first method is to present a triggering condition so that the same carrier maximum transmission power P_{cmax,c} is not continuously transmitted for the same scheduling configuration. The second method is to produce one field, representing the same values when P_{cmax,c} values transmitted according to triggering are the same, and to configure an MAC control element including the one field. According to the two kinds of the methods, a waste of uplink resources can be prevented, and efficiency of an uplink grant into which uplink control is taken into consideration can be improved. A method of defining and representing the carrier maximum transmission power is described below. Furthermore, the structure of an MAC control element according to the second method is described in detail.

1. Method of Defining and Representing Carrier Maximum Transmission Power

The carrier maximum transmission power P_{cmax,c} is represented by dB as a maximum transmission power that may be outputted per UL CC. The carrier maximum transmission power may have a range value, such as 20 dB≦P_{cmax.c}<22 dB or may have a constant, such as P_{cmax.c}=20 dB. The amount of the carrier maximum transmission power may be quantized and represented in unit of dB having a specific amount (e.g., 1 dB). That is, the carrier maximum transmission power P_{cmax,c} may be represented by 1 dB, 2 dB, 3 dB, or the like. In some embodiments, the carrier maximum transmission power may be differently configured for every UL CC or may be configured to have the same value. For example, a UL CC1 may be set to a carrier maximum transmission power P_{cmax.c1}, and both a UL CC2 and a UL CC3 may be set to a carrier maximum transmission power P_{cmax.c2}.

The carrier maximum transmission power is divided into at least one level having a specific range. There is a difference in dB of a specific amount or a variable amount between the levels. Furthermore, a mobile station and a base station operate a range mapping table in which an index has been assigned to each of the levels. If the range mapping table is used, the amount of the carrier maximum transmission power can be effectively represented using only the index. The size of the range mapping table is determined according to the amount of information (e.g., the number of bits) which is used to report the carrier maximum transmission power. A range report on the carrier maximum transmission power and a report on the carrier maximum transmission power are used to have the same meaning and are hereinafter called the report on the carrier maximum transmission power for the unity of the terms.

The number of bits indicating the carrier maximum transmission power is different according to definition in a system. If the number of bits is many, a power report or a wider range or a finer range may be possible. If a mobile station consumes a lot of uplink resources in order to report the carrier maximum transmission power to a base station, however, system performance may be greatly deteriorated. Accordingly, there is a need for a method of minimizing the amount of information which is necessary to report the carrier maximum transmission power. A method of representing the carrier maximum transmission power by 3 bits or 5 bits is described below, but this is only illustrative. The number of bit does not limit is the present invention.

Table 1 shows the range mapping table according to an example of the present invention. Table 1 shows an example in which 3 bits are used to report the carrier maximum transmission power.

TABLE 1

| Index | P_{cmax.c} (dB) Range Report |
|---|---|
| 0 | P_{cmax.c} ≧ 22 (or 22 ≦ P_{cmax.c} ≦ 23) |
| 1 | 20 ≦ P_{cmax.c} < 22 |
| 2 | 18 ≦ P_{cmax.c} < 20 |
| 3 | 16 ≦ P_{cmax.c} < 18 |
| 4 | 14 ≦ P_{cmax.c} < 16 |
| 5 | 12 ≦ P_{cmax.c} < 14 |
| 6 | 10 ≦ P_{cmax.c} < 12 |
| 7 | P_{cmax.c} < 10 |

Referring to Table 1, the range of the carrier maximum transmission power is classified into 8 levels. Furthermore, the index indicates the range of the carrier maximum transmission power, classified into the eight levels, using 3 bits. For example, the index 3 indicates that the range of the carrier maximum transmission power is 16 P<P_{cmax.c}<18. As described above, one index is mapped to the range of one carrier maximum transmission power. A mobile station may determine a range to which the carrier maximum transmission power belongs and report the carrier maximum transmission power in the form of an index mapped to the determined range. For example, assuming that a UL CC1 and a UL CC2 are mapped to a mobile station, the mobile station may report the index 2 for the UL CC1 to a base station and report the index 5 for the UL CC2 to the base station. The levels of the range of the carrier maximum transmission power have a difference of a specific amount (i.e., a 2 dB interval).

In the range mapping table, the range of the carrier maximum transmission power may vary according to the power class P_{powerclass} of a mobile station. The power class of the mobile station is a maximum output power for a specific transmission bandwidth within a is channel bandwidth. For example, the power class of the mobile station defined in an LTE system may include a total of 4 kinds. From among the 4 kinds, a maximum transmission power defined in the power class 3 is 23 dB. The power class is measured as at least 1 subframe cycle, and the range of a maximum power reduction (MPR) is dependently set in the power class.

Table 2 shows the range mapping table according to another example of the present invention. This table shows an example in which 4 bits are used to report the carrier maximum transmission power and shows an example in which there is 1 dB difference between levels in the range of the carrier maximum transmission power.

TABLE 2

| Index | P_{cmax.c} (dB) Range Report |
|---|---|
| 0 | P_{cmax.c} ≧ 22 (or 22 ≦ P_{cmax.c} ≦ 23) |
| 1 | 21 ≦ P_{cmax.c} < 22 |
| 2 | 20 ≦ P_{cmax.c} < 21 |
| 3 | 19 ≦ P_{cmax.c} < 20 |
| 4 | 18 ≦ P_{cmax.c} < 19 |
| 5 | 17 ≦ P_{cmax.c} < 18 |
| 6 | 16 ≦ P_{cmax.c} < 17 |
| 7 | 15 ≦ P_{cmax.c} < 16 |
| 8 | 14 ≦ P_{cmax.c} < 15 |
| 9 | 13 ≦ P_{cmax.c} < 14 |
| 10 | 12 ≦ P_{cmax.c} < 13 |
| 11 | 11 ≦ P_{cmax.c} < 12 |
| 12 | 10 ≦ P_{cmax.c} < 11 |
| 13 | 9 ≦ P_{cmax.c} < 10 |
| 14 | 8 ≦ P_{cmax.c} < 9 |
| 15 | P_{cmax.c} < 8 |

Referring to Table 2, the range of the carrier maximum transmission power is classified into a total of 16 levels. Furthermore, the index indicates the range of the carrier maximum transmission power, classified into the 16 levels, using 4 bits. For example, the index 3 indicates that the range of the carrier maximum transmission power is 19≦P_{cmax.c}<20.

The table may be configured using a method of setting a dB difference between the levels of lower indices on the basis of the power class. This is shown in Table 3.

TABLE 3

| Index | P_{cmax.c} (dB) Range Report |
|---|---|
| 0 | P_{powerclass} |
| 1 | P_{powerclass}-1 ≦ P_{cmax.c} < P_{powerclass} |
| 2 | P_{powerclass}-2 ≦ P_{cmax.c} < P_{powerclass}-1 |
| 3 | P_{powerclass}-3 ≦ P_{cmax.c} < P_{powerclass}-2 |
| 4 | P_{powerclass}-4 ≦ P_{cmax.c} < P_{powerclass}-3 |
| 5 | P_{powerclass}-5 ≦ P_{cmax.c} < P_{powerclass}-4 |
| 6 | P_{powerclass}-6 ≦ P_{cmax.c} < P_{powerclass}-5 |
| 7 | P_{powerclass}-7 ≦ P_{cmax.c} < P_{powerclass}-6 |
| 8 | P_{powerclass}-8 ≦ P_{cmax.c} < P_{powerclass}-7 |
| 9 | P_{powerclass}-9 ≦ P_{cmax.c} < P_{powerclass}-8 |
| 10 | P_{powerclass}-10 ≦ P_{cmax.c} < P_{powerclass}-9 |
| 11 | P_{powerclass}-11 ≦ P_{cmax.c} < P_{powerclass}-10 |
| 12 | P_{powerclass}-12 ≦ P_{cmax.c} < P_{powerclass}-11 |
| 13 | P_{powerclass}-13 ≦ P_{cmax.c} < P_{powerclass}-12 |
| 14 | P_{powerclass}-14 ≦ P_{cmax.c} < P_{powerclass}-13 |
| 15 | P_{powerclass}-15 ≦ P_{cmax.c} < P_{powerclass}-14 |

Referring to Table 3, there is 1 dB difference between the levels of all the indices.

Table 4 shows the range mapping table according to yet another example of the present invention. This table shows an example in which 5 bits are used to report the carrier maximum transmission power and shows an example in which there is a 1 dB difference between the levels of the ranges of the carrier maximum transmission power.

TABLE 4

| Index | P_{cmax.c} (dB) Range Report |
|---|---|
| 0 | P_{cmax.c} ≧ 22 (or 22 ≦ P_{cmax.c} ≦ 23) |
| 1 | 21 ≦ P_{cmax.c} < 22 |
| 2 | 20 ≦ P_{cmax.c} < 21 |
| 3 | 19 ≦ P_{cmax.c} < 20 |
| 4 | 18 ≦ P_{cmax.c} < 19 |
| 5 | 17 ≦ P_{cmax.c} < 18 |
| 6 | 16 ≦ P_{cmax.c} < 17 |
| 7 | 15 ≦ P_{cmax.c} < 16 |
| 8 | 14 ≦ P_{cmax.c} < 15 |
| 9 | 13 ≦ P_{cmax.c} < 14 |
| 10 | 12 ≦ P_{cmax.c} < 13 |
| 11 | 11 ≦ P_{cmax.c} < 12 |
| 12 | 10 ≦ P_{cmax.c} < 11 |
| 13 | 9 ≦ P_{cmax.c} < 10 |
| 14 | 8 ≦ P_{cmax.c} < 9 |
| 15 | 7 ≦ P_{cmax.c} < 8 |
| 16 | 6 ≦ P_{cmax.c} < 7 |
| 17 | 5 ≦ P_{cmax.c} < 6 |
| 18 | 4 ≦ P_{cmax.c} < 5 |
| 19 | 3 ≦ P_{cmax.c} < 4 |
| 20 | 2 ≦ P_{cmax.c} < 3 |
| 21 | 1 ≦ P_{cmax.c} < 2 |
| 22 | 0 ≦ P_{cmax.c} < 1 |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

Referring to Table 4, the range of the carrier maximum transmission power is classified into a total of 32 levels. Furthermore, the index indicates the range of the carrier maximum transmission power, classified into the 32 levels, using 5 bits. For example, the index 19 indicates that the range of the carrier maximum transmission power is 1≦P_{cmax.c}<4. Since the maximum transmission power must be greater than 0, the range of the maximum transmission power mapped to the remaining indices 23 to 31 does not exist. Accordingly, the indices 23 to 31 remain as reserved code points.

Each of Tables 1 to 4 has a 1 dB difference between the levels. The range mapping table may be configured so that there is an n dB difference between the levels or the range mapping table may be configured so that there is a variable difference between the levels.

2. Structure of Information for a Power Report

FIG. 9 is a block diagram showing the structure of an MAC Protocol Data Unit (MAC PDU) for a power report according to an example of the present invention. The MAC PDU is also called Transport Block (TB).

Referring to FIG. 9, the MAC PDU 900 includes an MAC header 910, one or more MAC control elements 920 to 925, one or more MAC Service Data Unit (MAC SDUs) 930-1 to 930-m, and padding 940.

The MAC control elements 920 to 925 are control messages generated by an MAC layer.

The MAC SDUs 930-1 to 930-m are the same as RLC PDUs transmitted from an Radio Link Control (RLC) layer. The padding 940 is a specific number of bits which are added is to make constant the size of the MAC PDU. The MAC control elements 920 to 925, the MAC SDUs 930-1 to 930-m, and the padding 940 are collectively called an MAC payload.

The MAC header 910 includes one or more sub-headers 910-1, 910-2 to 910-k. Each of the sub-headers 910-1, 910-2 to 910-k corresponds to one MAC SDU, one MAC control element, or the padding. The sequence of the sub-headers 910-1, 910-2 to 910-k is the same as that of the relevant MAC SDUs, MAC control elements, or paddings within the MAC PDU 900.

Each of the sub-headers 910-1, 910-2 to 910-k may include four fields, such as R, R, E, and LCID, or may include six fields, such as R, R, E, LCID, F, and L. The sub-header including the four fields is a sub-header corresponding to the MAC control element or the padding, and the sub-header including the six fields is a sub-header corresponding to the MAC SDU.

The LCID (Logical Channel ID) field is an ID field to identify a logical channel corresponding to the MAC SDU or to identify a type of the MAC control element or the padding, and the LCID field may have 5 bits.

For example, the LCID field identifies whether a relevant MAC control element is a power headroom MAC control element for transmitting power headroom, whether a relevant MAC control element is a feedback request MAC control element to request feedback information from a mobile station, whether a relevant MAC control element is a Discontinuous Reception (DRX) command MAC control element regarding a discontinuous reception command, or whether a relevant MAC control element is a contention resolution identity MAC control element for solving a contention between mobile stations.

Furthermore, according to the present invention, the LCID field may identify whether a relevant MAC control element is the MAC control element for a power report. One LCID field exists for each of the MAC SDU, the MAC control element, and the padding. Table 5 shows an example of the LCID field.

TABLE 5

| Index | LCID Values |
|---|---|
| 00000 | CCCH |
| 00001-01010 | Identity of logical channel |
| 01011-10111 | Reserved |
| 11000 | Scell activation/deactivation |
| 11001 | Reference CC Indicator |
| 11010 | Power Report (CA) |
| 11011 | C-RNTI |
| 11100 | Truncated BSR |
| 11101 | Short BSR |
| 11110 | Long BSR |
| 11111 | Padding |

Referring to Table 5, the LCID field value 11010 may indicate that a relevant MAC control element is the MAC control element for a power report on one or more component carriers according to the present invention. The MAC control element for the power report includes at least one of power headroom information and carrier maximum transmission power information (P_{cmax,c} information). The power headroom information includes at least one Power Headroom Field (PHF) and an additional field related to the PHF. The carrier maximum transmission power information includes at least one carrier maximum transmission power field and an additional field related to the at least one carrier maximum transmission power field. Here, the field is at least one bit indicating meaningful information. For example, the power headroom field may be a field indicating power headroom, and the carrier maximum transmission power field may be a field indicating the carrier maximum transmission power. The number of bits of the fields varies according to a system.

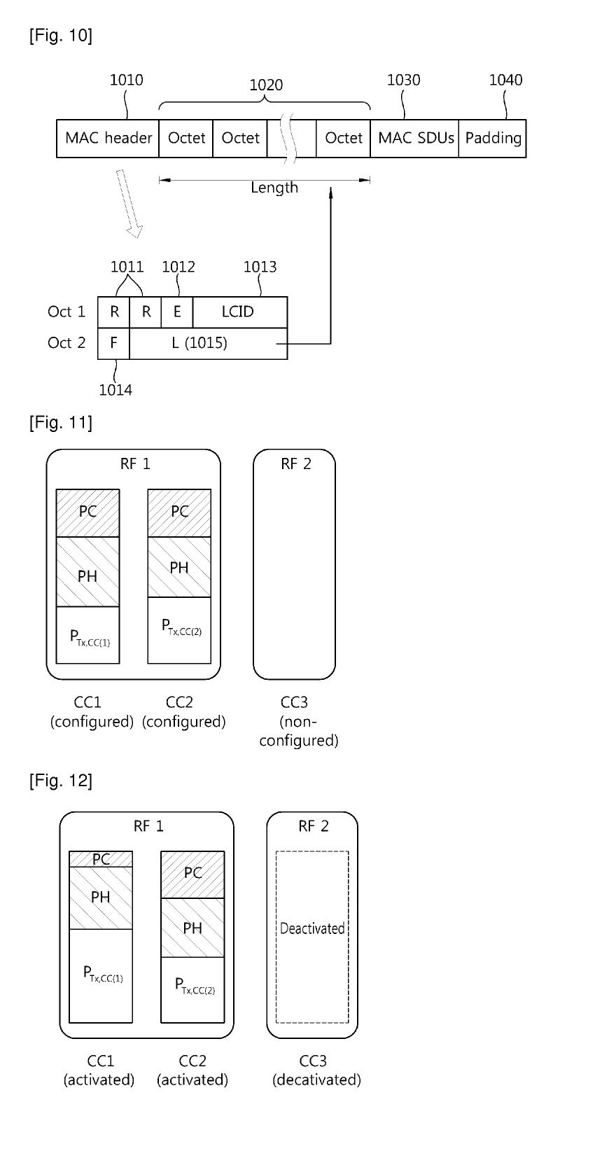

FIG. 10 is a block diagram showing the structure of the MAC PDU for a power report according to another example of the present invention.

Referring to FIG. 10, the MAC PDU 1000 includes an MAC header 1010, an MAC control element 1020 for a power report, MAC SDUs 1030, and a padding 1040.

The MAC header 1010 includes at least one MAC sub-header (not shown). Each of the MAC sub-header and the MAC control element 1020 for a power report consists of an octet unit. The octet indicates information having an 8-bit length. For example, the MAC sub-header may include R fields 1011, an E field 1012, an LCID field 1013, an F field 1014, and an L field 1015.

The L field 1015 indicates the length of the MAC control element 1020 for a relevant power report in the form of a byte unit. The MAC control element 1020 for a power report includes at least one octet, and each octet includes any one of power headroom information and a carrier maximum transmission power. Accordingly, the MAC control element 1020 for a power report may include both or any one of the power headroom information and the carrier maximum transmission power.

3. Power Report Cell Group (PRCG) and Identical Power Cell Group (IPCG)

(1) PRCG

If a power report on a CC is to be made, whether power regarding what CC is reported must be first negotiated between a mobile station and a base station. This is because, is although a mobile station has reported a first carrier maximum transmission power regarding a CC1, a base station is unable to check whether the first carrier maximum transmission power is about the CC1 or a CC2. Accordingly, CCs to be reported must be specified. A set of CCs to be reported is called a Power Report Cell Group (PRCG). Accordingly, a carrier maximum transmission power for only CCs belonging to the PRCG is reported, but a carrier maximum transmission power for CCs not belonging to the PRCG is not reported.

More particularly, there are a first mode where a mobile station dynamically informs a base station that what CC belongs to the PRCG in the form of bitmap information and a second mode where an agreement between a mobile station and a base station is previously performed. In case of the first mode, the bitmap information may be included in an MAC control element. Here, the bitmap information may be placed in the front end of the MAC control element, may be included in an MAC control element for a power headroom report, or may be included in an MAC control element for a maximum transmission power report.

There may be several criteria for selecting the PRCG.

For example, all cells configured in a mobile station may be selected as the PRCG.

FIG. 11 is an explanatory diagram illustrating an example of a method of selecting the PRCG.

Referring to FIG. 11, three CCs CC1, CC2, and CC3 are configured in a mobile station. The CC1 and the CC2 are included in an RF1, and the CC3 is included in an RF2.

For another example, only activated cells may be selected as the PRCG.

FIG. 12 is an explanatory diagram illustrating another example of the method of selecting the PRCG.

Referring to FIG. 12, in the state in which three CCs; CC1, CC2, and CC3 are configured in a mobile station, only the CC1 and the CC2 are activated, but the CC3 is in a deactivation state. Here, the term ‘deactivation state’ means that the transmission of data and control information is not performed until an activation command is generated through a relevant CC. The state of FIG. 12 shows an example in which the number of CCs available for transmission is 3, but CCs actually used for transmission are the CC1 and the CC2.

For yet another example, only scheduled cells may be selected as the PRCG.

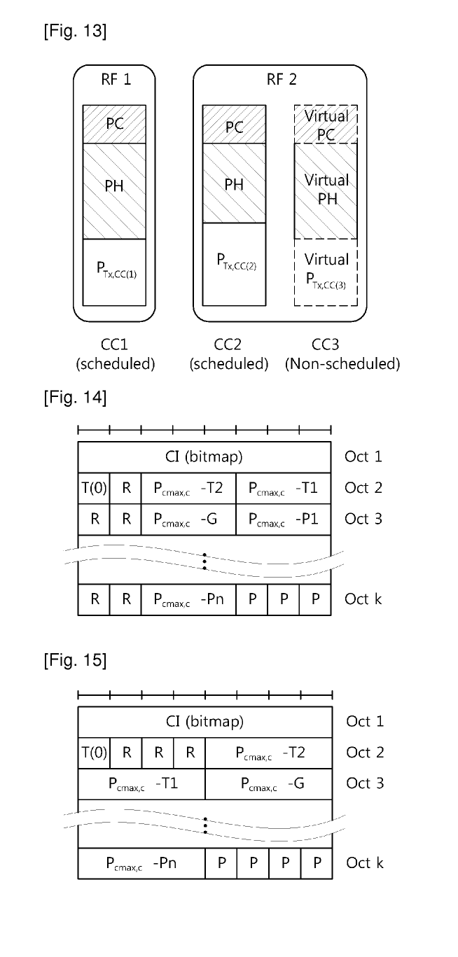

FIG. 13 is an explanatory diagram illustrating yet another example of the method of selecting the PRCG.

Referring to FIG. 13, in the state in which three CCs; CC1, CC2, and CC3 are configured in a mobile station, only the CC1 and the CC2 have been scheduled. Here, the CC3 has not been actually scheduled, but power headroom (PH) for the CC3 is calculated on the basis of virtual resource allocation and an MCS level. The reason why the virtual CC power headroom is required is that, although a CC has not been scheduled in a current frame, a base station has to detect a change in the pass loss for the relevant CC when the relevant CC is subsequently scheduled. In general, power headroom for a scheduled CC may be calculated irrespective of virtual power headroom.

An algorithm for selecting the PRCG is an issue of implementation. One possible example is that, when the same P_{cmax,c} value is used in the same scheduling configuration, P_{cmax,c} is not transmitted from a mobile station to a base station. In this case a base station will replace the P_{cmax,c} value for the relevant scheduling configuration with the existing P_{cmax,c} value.

(2) IPCG

A problem of a waste of resources due to the redundant transmission of the same carrier maximum transmission power field for different CCs must be solved. To this end, a mobile station selects a plurality of CCs having the same carrier maximum transmission power, from among a plurality of CCs belonging to a PRCG. Furthermore, the mobile station configures one representative carrier maximum transmission power field for the plurality of selected CCs as an MAC control element. The plurality of selected CCs is referred to as an Identical Power Cell Group (IPCG). The IPCG is a subset of PRCGs. A mobile station may include an additional cell indicator, indicating CCs belonging to the IPCG, in an MAC control element.

What carrier maximum transmission power values of different CCs have the identity property means that not only a plurality of maximum transmission power values are quantitatively identical with each other, but also a difference between the maximum transmission power values falls within a predetermined critical value.

(3) Type of a Field

An MAC control element for a power report includes at least one of a Type Indicator Field (TIF), a Cell Indicator Field (CIF), an R field, a P field, and a carrier maximum transmission power field (P_{cmax,c} Field).

The TIF indicates whether the type 1 maximum transmission power and the type 2 maximum transmission power of a primary serving cell (PSC) are identical with each other or different from each other. Although the PSC does not belong to an IPCG, a case where the type 1 maximum transmission power is identical with the type 2 maximum transmission power may exist. Whether the type 1 maximum transmission power and the type 2 maximum transmission power are identical with or different from each other cannot be distinguished using only the CIF. Whether the type 1 maximum transmission power and the type 2 maximum transmission power are identical with or different from each other power, however, may be known using the TIF.

If the type 1 maximum transmission power and the type 2 maximum transmission power are different from each other, there is need for a carrier maximum transmission power field for each of the type 1 maximum transmission power and the type 2 maximum transmission power. On the other hand, if the type 1 maximum transmission power and the type 2 maximum transmission power are identical with each other, a mobile station does not nee to redundantly transmit the same maximum transmission power. In this case, only one carrier maximum transmission power field regarding a PSC is sufficient. In this aspect, the TIF indicates whether both the carrier maximum transmission power fields of the type 1 and the type 2 are included in the MAC control element for a power report or only one redundant carrier maximum transmission power field is included in the MAC control element for a power report.

The TIF is taken into consideration up to a maximum of 2 bits. Accordingly, there is an advantage in that the number of bits of information necessary for a power report is reduced when the type 1 and the type 2 maximum transmission powers are identical with each other.

The TIF is a criterion for determining whether the type 1 maximum transmission power and the type 2 maximum transmission power of the PSC are identical with or different from each other. Accordingly, whether the type 1 maximum transmission power and the type 2 maximum transmission power of the PSC are identical with or different from a carrier maximum transmission power regarding other CC is not informed. Here, the carrier maximum transmission power regarding other CC may be determined in association with the CIF bit value of the PSC.

Meanwhile, the TIF may be included or not included in the MAC control element is for a power report. If the PSC belongs to the PRCG, the TIF is included in the MAC control element for a power report. On the other hand, if the PSC does not belong to the PRCG, the TIF is not included in the MAC control element for a power report.

The CIF is a field indicating a CC (or cell) belonging to an IPCG. The CIF may have a bitmap form. In other words, one bit indicates whether one cell belonging to a PRCG is subjected to 1:1 mapping, and the value of the bit indicates whether the cell belongs to an IPCG. That is, if the bit value is ‘1’, it means that the cell belongs to the IPCG. If the bit value is ‘0’, it means that the cell does not belong to the IPCG. For example, it is assumed that the CIF is an 8-bit bitmap and is ‘hgfedcba’. It is assumed that eight CCs 0, CC1, CC2 to CC7 belonging to a PRCG are mapped to respective bits. That is, the CC0 is mapped to a, the CC1 is mapped to b, the CC2 is mapped to c, the CC3 is mapped to d, the CC4 is mapped to e, the CC5 is mapped to f, the CC6 is mapped to g, and the CC7 is mapped to h. If the CC0, CC2, and CC7 belong to an IPCG, a=1, c=1, h=1, and the remaining b=d=e=f=g=0. Accordingly, the CIF becomes 10000101. This means that the carrier maximum transmission power of the CC0, the carrier maximum transmission power of the CC2, and the carrier maximum transmission power of the CC7 are identical with each other.

In the above example, it has been assumed that all the CCs belong to the PRCG. However, some of the CCs may do not belong to the PRCG. A bit corresponding to a CC not belonging to the PRCG, from among the bits of a CIF, does not have any meaning. This bit is called a D field. The D field indicates a field which is not taken into consideration (don't cared) according to an agreement between a mobile station and a base station. The CIF may include or may do not include the D field. In the above example, it is assumed that 5 CCs CC0, CC2, CC3, CC6, and CC7) of the total eight CCs belong to the PRCG and the remaining three CCs CC1, CC4, and CC5 do not belong to the PRCG. Bits corresponding to the remaining three CCs are indicated by the D fields. That is, it results in 10DD01D1.

In this case, a mobile station and a base station may configure a PSC as the D field. In principle, the D field is configured when it does not belong to the PRCG. Although the PSC exceptionally belongs to the PRCG, it may be configured as the D field. Although the PSC is configured as the D field, carrier maximum transmission power information about the CCs of the PSC is transmitted to the base station. On the other hand, what an SSC is configured as the D field means that the SSC does not belong to the PRCG. In this case, a report on a maximum transmission power is not performed.

The R field indicates reserved bits not including meaningful information.

The P field refers to a padding bit. The padding is a bit which is added in order to make the MAC control element a multiple of an octet. The padding does not include meaningful information.

The carrier maximum transmission power field has the following five types as in Table 6.

TABLE 6
Carrier maximum transmission power field

| P_{cmax, c} Field | Description |
|---|---|
| P_{cmax, c}-T2 Field | Indicate carrier maximum transmission |
| | power for UL PCC of type 2 |
| P_{cmax, c}-T1 Field | Indicate carrier maximum transmission |
| | power for UL PCC of type 1 |
| P_{cmax, c}-T Field | Indicate carrier maximum transmission |
| | power when carrier maximum transmission |
| | powers for UL PCCs of type 1 and type 2 |
| | are identical with each other |
| P_{cmax, c}-G Field | Indicate carrier maximum transmission |
| | power representatively indicating a |
| | CC belonging to IPCG |
| P_{cmax, c}-P Field | Indicate carrier maximum transmission |
| | power for each of CCs not belonging |
| | to IPCG, but belonging to PRCG |

Referring to Table 6, the five types of carrier maximum transmission power fields have the same number of bits and indicate the same quality of information (carrier maximum transmission power). They may be included in the MAC control element for one power report.

If separate indicators for distinguishing the five types of carrier maximum transmission power fields from each other are not included in the MAC control element, the five types of carrier maximum transmission power fields may be distinguished from each other on the basis of an arrangement sequence. A rule for the sequence arrangement of the fields is as follows. For example, the P_{cmax,c}-T2 field and the P_{cmax,c}-T1 field or the P_{cmax,c}-T field, the P_{cmax,c}-G field, and the P_{cmax,c}-P field may be arranged in this order within the MAC control element for a power report. In some embodiments, the P_{cmax,c}-T1 field and the P_{cmax,c}-T2 field or the P_{cmax,c}-T field, the P_{cmax,c}-G field, and the P_{cmax,c}-P field may be arranged in this order within the MAC control element for a power report. A plurality of the P_{cmax,c}-P fields may be arranged according to a rule previously agreed between a mobile station and a base station. For example, the plurality of the P_{cmax,c}-P fields may be arranged in order of cell indices. Whether the plurality of the P_{cmax,c}-P fields will be arranged in an ascending powers or a descending powers may be determined according to a rule defined in a system. For example, assuming that the P_{cmax,c}-P1=cell index 2, the P_{cmax,c}-P2=cell index 3, and the P_{cmax,c}-P3=cell index 1, the P_{cmax,c}-P3, is the P_{cmax,c}-P1, and the P_{cmax,c}-P2 may be arranged in this order if the ascending powers rule has been agreed.

The P_{cmax,c}-T1 field/the P_{cmax,c}-T2 field and the P_{cmax,c}-T field are exclusive to each other. In other words, if any one of the P_{cmax,c}-T1 field and the P_{cmax,c}-T2 field is included in the MAC control element for a power report, the P_{cmax,c}-T field is not included in the MAC control element for a power report. On the other hand, if the P_{cmax,c}-T field is included in the MAC control element for a power report, the P_{cmax,c}-T1 field and the P_{cmax,c}-T2 field are not included in the MAC control element for a power report. This is because the P_{cmax,c}-T field is an independent field which is used in order to avoid redundant transmission when the P_{cmax,c}-T1 field and the P_{cmax,c}-T2 field are identical with each other. Whether the P_{cmax,c}-T1 field/the P_{cmax,c}-T2 field or the P_{cmax,c}-T field is included in the MAC control element for a power report is indicated by the TIF.

(4) Relationship Between TIF and CIF

The TIF and the CIF have the following similarities and differences. The TIF and the CIF are similar to each other in that they inform whether several carrier maximum transmission power values are identical with each other. In this aspect, the TIF and the CIF are factors to determine the structure of the MAC control element for a power report. On the other hand, the TIF and CIF are different from each other in that whether maximum transmission powers are identical with each other according to the TIF is limited to the type 1 and the type 2 for the CCs of a PSC, and whether maximum transmission powers are identical with each other according to the CIF is for all CCs belonging to a PRCG.

The TIF uses only the CCs of a PSC as the subject, but the CIF uses all CCs as the subject. Accordingly, a bit value and a TIF value which are related to a PSC in the CIF are is organically combined to produce meaningful information.

For example, when the TIF is 1 bit, the structure (in particular, a P_{cmax,c}-T1 field, a P_{cmax,c}-T2 field, and a P_{cmax,c}-T field) of the MAC control element for a power report (P_{cmax,c} MAC CE) may be determined according to the following table.

TABLE 7

| | Bit value | |
|---|---|---|
| TIF | corresponding | |
| value | to PSC in CIF | P_{cmax, c} MAC CE Structure |
| 0 | 0 | Include P_{cmax, c}-T1 field and |
| | | P_{cmax, c}-T2 field |
| 0 | 1 | Include P_{cmax, c}-T2 field |
| | | (P_{cmax, c}-T1 field belongs to P_{cmax, c}-G field) |
| 1 | 0 | Include P_{cmax, c}-T field |
| 1 | 1 | Not include all P_{cmax, c}-T1 field, |
| | | P_{cmax, c}-T2 field, and P_{cmax, c}-T1 field |

Referring to Table 7, a carrier maximum transmission power field included in the MAC control element for a power report is determined by a combination {a,b} of a TIF value and a bit value related to a PSC in the CIF. Basically, if the TIF value is 0, it means that the type 1 maximum transmission power and the type 2 maximum transmission power are different from each other. If the TIF value is 1, it means that the type 1 maximum transmission power and the type 2 maximum transmission power are identical with each other.

If the combination is {0, 0}, the type 1 maximum transmission power and the type 2 maximum transmission power are different from each other and are also different from the maximum transmission power of a different CC in a PSC. Accordingly, the MAC control to element for a power report includes the P_{cmax,c}-T1 field and the P_{cmax,c}-T2 field.

If the combination is {0, 1}, the type 1 maximum transmission power and the type 2 maximum transmission power are different from each other, but are identical with the maximum transmission power of a different CC in a PSC. This means that any one of the type 1 maximum transmission power and the type 2 maximum transmission power is identical with the is maximum transmission power of a different CC in a PSC. In this case, it is considered that the type 1 maximum transmission power is identical with the maximum transmission powers of other CCs by default. In other words, the P_{cmax,c}-T1 field is replaced with the P_{cmax,c}-G field, and only the P_{cmax,c}-T2 field is explicitly included in the MAC control element for a power report.

If the combination is {1, 0}, it means that the type 1 maximum transmission power and the type 2 maximum transmission power are identical with each other, but different from the maximum transmission power of a different CC in a PSC. Accordingly, the MAC control element for a power report includes only the P_{cmax,c}-T field.

If the combination is {1, 1}, it means that the type 1 maximum transmission power and the type 2 maximum transmission power are identical with each other and also identical with the maximum transmission power of a different CC in a PSC. Accordingly, the MAC control element for a power report does not include all the P_{cmax,c}-T1 field, the P_{cmax,c}-T2 field, and the P_{cmax,c}-T field, but includes only the P_{cmax,c}-G field.

For another example, if the TIF is 2 bits, the structure in particular, a P_{cmax,c}-T1 field, a P_{cmax,c}-T2 field, and a P_{cmax,c}-T field) of the MAC control element for a power report (P_{cmax,c} MAC CE) (may be determined according to the following table.

TABLE 8

| | Bit value | |
|---|---|---|
| TIF | corresponding | |
| value | to PSC in CIF | P_{cmax, c} MAC CE Structure |
| 00 | 0 | Include P_{cmax, c}-T1 field and P_{cmax, c}-T2 field |
| 00 | 1 | Include only P_{cmax, c}-T2 field (P_{cmax, c}-T1 field |
| | | belongs to P_{cmax, c}-G field) |
| 01 | 0 | Include only P_{cmax, c}-T1 fiel |
| 01 | 1 | Not include all P_{cmax, c}-T1 field, P_{cmax, c}-T2 |
| | | field, and P_{cmax, c}-T1 field |
| 10 | 0 | Include only P_{cmax, c}-T2 field |
| 10 | 1 | Not include all P_{cmax, c}-T1 field, P_{cmax, c}-T2 |
| | | field, and P_{cmax, c}-T1 field |
| 11 | 0 | Include P_{cmax, c}-T field |
| 11 | 1 | Not include all P_{cmax, c}-T1 field, P_{cmax, c}-T2 |
| | | field, and P_{cmax, c}-T1 field |

Referring to Table 8, a carrier maximum transmission power field including the MAC control element for a power report is determined by a combination {ab,c} of a TIF value and a bit value related to a PSC in the CIF. Basically, if the TIF value is 00, it means that the type 1 maximum transmission power and the type 2 maximum transmission power are different from each other. Meanwhile, if the TIF value is 01, it means that the MAC control element for a power report includes only the P_{cmax,c}-T1 field. If the TIF value is 10, it means that the MAC control element for a power report includes only the P_{cmax,c}-T2 field. Furthermore, if the TIF value is 11, it means that the type 1 maximum transmission power and the type 2 maximum transmission power are identical with each other.

If the combination is {00, 0}, the type 1 maximum transmission power and the type 2 maximum transmission power are different from each other and are also different from maximum transmission power of a different CC in a PSC. Accordingly, the MAC control element for a power report includes both the P_{cmax,c}-T1 field and the P_{cmax,c}-T2 field.

If the combination is {00, 1}, the type 1 maximum transmission power and the is type 2 maximum transmission power are different from each other, but are identical with the maximum transmission power of a different CC in a PSC. It means that any one of the type 1 maximum transmission power and the type 2 maximum transmission power is identical with the maximum transmission power of a different CC in a PSC. In this case, the type 1 maximum transmission power is considered to be identical with the maximum transmission powers of other CC5 by default. In other words, the P_{cmax,c}-T1 field is replaced with the P_{cmax,c}-G field, and only the P_{cmax,c}-T2 field is explicitly included in the MAC control element for a power report.

If the combination is {01, 0}, the MAC control element for a power report includes only the P_{cmax,c}-T1 field and differs from the maximum transmission power of a different CC in a PSC. Accordingly, the MAC control element for a power report includes only the P_{cmax,c}-T1 field.

If the combination is {01, 1}, the MAC control element for a power report includes only the P_{cmax,c}-T1 field, and it is also identical with the maximum transmission power of a different CC in a PSC. In other words, the type 1 maximum transmission power is identical with the maximum transmission powers of the different CCs. Accordingly, the P_{cmax,c}-T1 field of the MAC control element for a power report is replaced with the P_{cmax,c}-G field, and the MAC control element for a power report does not include all the P_{cmax,c}-T1 field, the P_{cmax,c}-T2 field, and the P_{cmax,c-T} field.

If the combination is {10, 0}, the MAC control element for a power report includes only the P_{cmax,c}-T2 field, and it is different from the maximum transmission power of a different CC in a PSC. Accordingly, the MAC control element for a power report includes only the P_{cmax,c}-T2 field.

If the combination is {10, 1}, the MAC control element for a power report includes only the P_{cmax,c}-T2 field, and it is identical with the maximum transmission power of a different CC in a PSC. In other words, the type 2 maximum transmission power is identical with the maximum transmission powers of the different CCs. Accordingly, the P_{cmax,c}-T2 field of the MAC control element for a power report is replaced with the P_{cmax,c}-G field, and the MAC control element for a power report does not include all the P_{cmax,c}-T1 field, the P_{cmax,c}-T2 field, and the P_{cmax,c}-T field.

If the combination is {11, 0}, it means that the type 1 maximum transmission power and the type 2 maximum transmission power are identical with each other and are different from the maximum transmission power of a different CC in a PSC. Accordingly, the MAC control element for a power report includes only the P_{cmax,c}-T field.

If the combination is {11, 1}, it means that the type 1 maximum transmission power and the type 2 maximum transmission power are identical with each other and are also identical with the maximum transmission power of a different CC in a PSC. Accordingly, the P_{cmax,c}-T field of the MAC control element for a power report is replaced with the P_{cmax,c}-G field, and the MAC control element for a power report does not include all the P_{cmax,c}-T1 field, the P_{cmax,c}-T2 field, and the P_{cmax,c}-T field.

As described above, the structure of the MAC control element for a power report may be indicated by not only the number of bits of the TIF and the contents of indication, but is also an organic relationship with the CIF.

The structure of the MAC control element for a power report may be determined by a classification unit of information, such as an octet. Hereinafter, the classification unit of information is described, and the structures of the MAC control element for a power report according to various cases are described.

4. Structure of MAC Control Element for a Power Report

The MAC control element for a power report may be chiefly divided into two kinds. One kind is an octet structure, and the other kind is a consecutive structure. The octet structure is a structure for separating pieces of meaningful information by a specific number of bits (e.g., in unit of 8 bits). Furthermore, a field exceeding one octet is included in the following octet. For example, it is assumed that there is a field a having a length of 3 bits. Although there are reserved 2 bits in a first octet, all the 3 bits of the field a are included in a new second octet. In other words, it is not that only 2 bits of the field a are included in the first octet, and the remaining 1 bit is included in the second octet.

Meanwhile, the consecutive structure is a structure in which fields are consecutively arranged. Accordingly, an additional R field is not included between the fields.

(1) 1-Bit TIF+Octet Structure

FIG. 14 shows the structure of an MAC control element for a power report according to an example of the present invention. FIG. 14 shows an example in which a TIF value is 0 and each P_{cmax,c} field has 3 bits.

Referring to FIG. 14, the MAC control element for a power report includes a CIF having a bitmap form, at least one R field, a TIF T, a P_{cmax,c}-T2 field, a P_{cmax,c}-T1 field, a P_{cmax,c}-G field, a P_{cmax,c}-P1 field to a P_{cmax,c}-Pn field, and at least one padding bit P. T(0) indicates that is the TIF value is 0, and T(1) indicates that the TIF value is 1.

The MAC control element for a power report is constructed of an 8-bit octet unit. The first octet Oct 1 includes the CIF having a length of 8 bits. The second octet Oct 2 includes the TIF T. Meanwhile, since the P_{cmax,c} field has 3 bits, one octet may include a maximum of two P_{cmax,c} fields. Accordingly, in the second octet, a 1 bit remained after one TIF T, two P_{cmax,c}-T2 fields, and P_{cmax,c}-T1 field are filled becomes the R field. A third octet Oct 3 includes the P_{cmax,c}-G field and the P_{cmax,c}-P1 field, and a k^{th} octet Oct k includes a P_{cmax,c}-Pn field. Here, n is equal to the number of CCs which belong to a PRCG other than a PSC, but does not belong to an IPCG.

FIG. 15 shows the structure of an MAC control element for a power report according to another example of the present invention. FIG. 15 shows an example in which a TIF value is 0 and each P_{cmax,c} field has 4 bits.

Referring to FIG. 15, the MAC control element for a power report is constructed of an 8-bit octet unit. Since the P_{cmax,c} field has 4 bits, one octet may include a maximum of two P_{cmax,c} fields. Since one TIF T exists in a second octet Oct 2, all 3 bits remained after one P_{cmax,c}-T2 field is filled becomes an R field. A third octet Oct 3 includes a P_{cmax,c}-T1 field and a P_{cmax,c}-G field, and a k^{th} octet Oct k includes a P_{cmax,c}-Pn field.

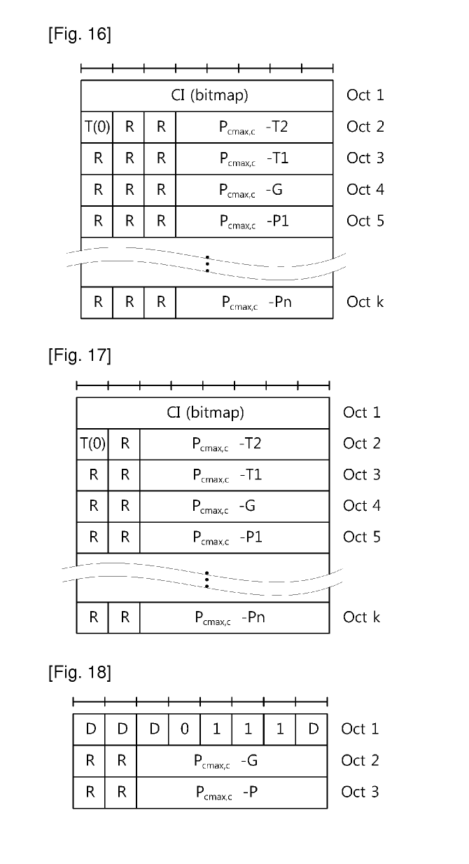

FIG. 16 shows the structure of an MAC control element for a power report according to yet another example of the present invention. FIG. 16 shows an example in which a TIF value is 0 and each P_{cmax,c} field has 5 bits.

Referring to FIG. 16, the MAC control element for a power report is constructed of an 8-bit octet unit. Since the P_{cmax,c} field has 5 bits, one octet may include a maximum one P_{cmax,c} field. Since one TIF T exists in a second octet Oct 2, all 2 bits remained after one P cmax,c T2 field is filled become an R field. A third octet Oct 3 includes one P_{cmax,c}-T1 field, a fourth octet Oct 4 includes one P_{cmax,c}-G field, and a k^{th} octet Oct k includes a P_{cmax,c}-Pn field.

FIG. 17 shows the structure of an MAC control element for a power report according to yet another example of the present invention. FIG. 17 shows an example in which a TIF value is 0 and each P_{cmax,c} field has 6 bits.

Referring to FIG. 17, the MAC control element for a power report is constructed of an 8-bit octet unit. Since the P_{cmax,c} field has 6 bits, one octet may include a maximum one P_{cmax,c} field. Since one TIF T exists in a second octet Oct 2, 1 bit remained after one P_{cmax,c}-T2 field is filled becomes an R field. A third octet Oct 3 includes one P_{cmax,c}-T1 field, a fourth octet Oct 4 includes one P_{cmax,c}-G field, and a k^{th} octet Oct k includes a P_{cmax,c}-Pn field.

FIG. 18 shows an example in which the MAC control element for a power report according to FIG. 17 is utilized. FIG. 18 shows an example in which a PSC is not included in a PRCG.

Referring to FIG. 18, the MAC control element for a power report includes a plurality of R fields, a CIF CI having a bitmap form, a P_{cmax,c}-G field, and a P_{cmax,c} field.

The CIF within a first octet Oct 1 is DDD0111D. A D field indicates that what CC is not included in the PRCG. It is assumed that bits are sequentially mapped to a CC0, a CC1, a CC2 to a CC7 from a bit on the most right side to a bit on the most left side. The CC0, the CC5, the CC6, and the CC7 are the D fields and are thus not included in the PRCG. The PRCG includes only the CC1, the CC2, the CC3, and the CC4. Since the CC0 (i.e., a PSC) has been configured as the D field, a P_{cmax,c}-T2 field and a P_{cmax,c}-T1 field which are P_{cmax,c} fields regarding the PSC are not included in the MAC control element for a power report. Since the carrier maximum transmission power regarding the PSC is not reported, the classification of a is type is meaningless. Accordingly, the MAC control element for a power report does not include the TIF.

Bit values corresponding to the CC1, the CC2, and the CC3 are 1. Accordingly, the CC1, the CC2, and the CC3 are included in an IPCG, and a second octet Oct 2 includes the P_{cmax,c}-G field. All carrier maximum transmission power values regarding the CC1, the CC2, and the CC3 are identical with a maximum transmission power value indicated by the P_{cmax,c}-G field. Furthermore, a maximum transmission power value regarding the CC4 is indicated by an individual P_{cmax,c} field within a third octet Oct 3.

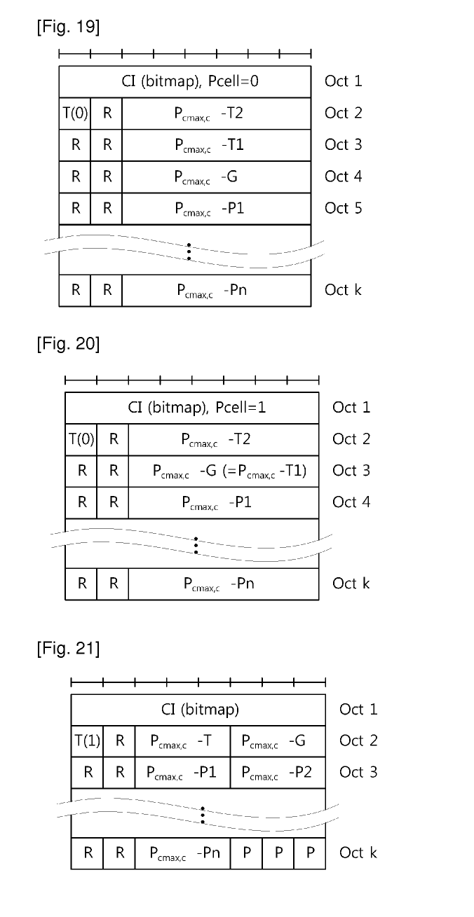

FIG. 19 shows another example in which the MAC control element for a power report according to FIG. 17 is utilized. FIG. 19 shows an example in which a PSC is included in a PRCG, but not included in an IPCG (i.e., when a CIF bit value is 0).

Referring to FIG. 19, the structure of the MAC control element for a power report corresponds to the combination {0, 0} in Table 7. Accordingly, the MAC control element for a power report includes a CIF CI, a TIF T, R fields, a P_{cmax,c}-T2 field, a P_{cmax,c}-T1 field, a P_{c,max}-G field, a P_{cmax,c}-P1 field to a P_{cmax,c}-Pn field.

FIG. 20 shows yet another example in which the MAC control element for a power report according to FIG. 17 is utilized. FIG. 20 shows an example in which a PSC is included in a PRCG and included in an IPCG (i.e., when a CIF bit value is 1).

Referring to FIG. 20, the structure of the MAC control element for a power report corresponds to the combination {0, 1} in Table 7. Accordingly, the MAC control element for a power report includes a CIF CI, a TIF T, R fields, a P_{cmax,c}-T2 field, a P_{cmax,c}-G field, a P_{cmax,c}-P1 field to a P_{cmax,c}-Pn field.

FIG. 21 shows the structure of an MAC control element for a power report is according to yet another example of the present invention. FIG. 21 shows an example in which a TIF value is 1 and each P_{cmax,c} field has 3 bits.

In FIG. 21, the P_{cmax,c}-T1 field and the P_{cmax,c}-T2 field are replaced with one P_{cmax,c}-T field, and the remaining fields remain intact, as compared with FIG. 14. This is because the TIF value indicates 1 (i.e., the type 1 maximum transmission power and the type 2 maximum transmission power are identical with each other).

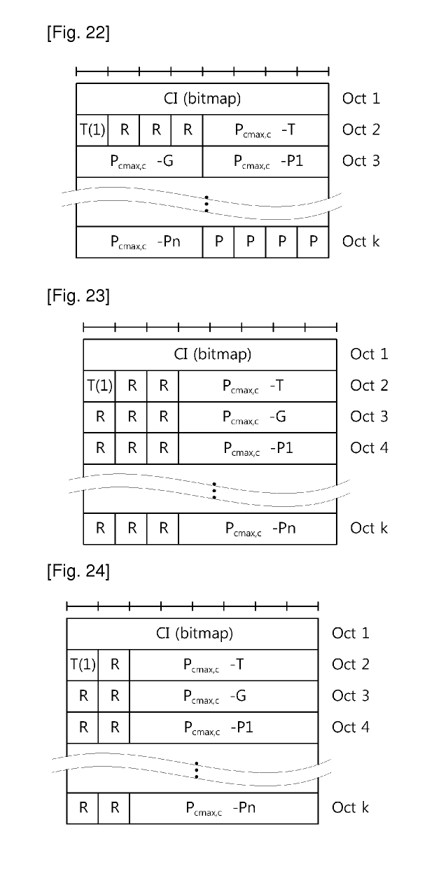

FIG. 22 shows the structure of an MAC control element for a power report according to further yet another example of the present invention. FIG. 22 shows an example in which a TIF value is 1 and each P_{cmax,c} field has 4 bits.

In FIG. 22, the P_{cmax,c}-T1 field and the P_{cmax,c}-T2 field are replaced with one P_{cmax,c}-T field, and the remaining fields remain intact, as compared with FIG. 15. This is because the TIF value indicates (i.e., the type 1 maximum transmission power and the type 2 maximum transmission power are identical with each other).

FIG. 23 shows the structure of an MAC control element for a power report according to still yet another example of the present invention. FIG. 23 shows an example in which the TIF value is 1 and each P_{cmax,c} field has 5 bits.

In FIG. 23, the P_{cmax,c}-T1 field and the P_{cmax,c}-T2 field are replaced with one P_{cmax,c}-T field and the remaining fields remain intact, as compared with FIG. 16. This is because the TIF value indicates 1 (i.e., the type 1 maximum transmission power and the type 2 maximum transmission power are identical with each other).

FIG. 24 shows the structure of an MAC control element for a power report according to further yet another example of the present invention. FIG. 22 shows an example in which the TIF value is 1 and each P_{cmax,c} field has 6 bits.

In FIG. 24, the P_{cmax,c}-T1 field and the P_{cmax,c}-T2 field are replaced with one P_{cmax,c}-T field, and the remaining fields remain intact, as compared with FIG. 17. This is because the TIF value indicates 1 (i.e., the type 1 maximum transmission power and the type 2 maximum transmission power are identical with each other).

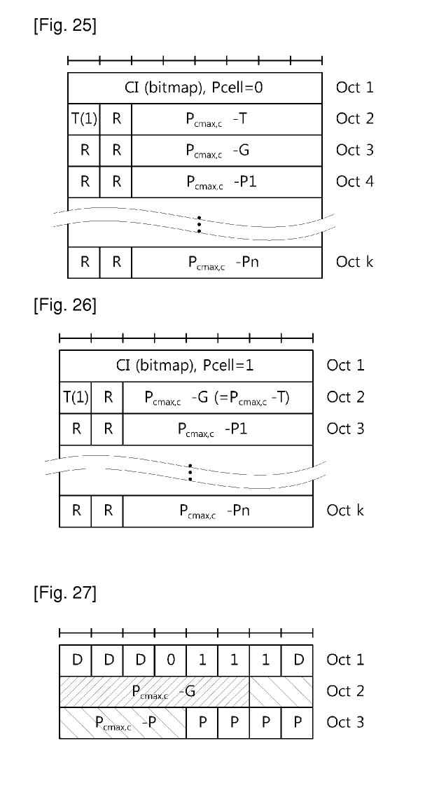

FIG. 25 shows an example in which the MAC control element for a power report according to FIG. 24 is utilized. FIG. 25 shows the example in which a PSC is included in a PRCG, but not included in an IPCG (i.e., when the bit value of a CIF is 0).

Referring to FIG. 25, the structure of the MAC control element for a power report corresponds to the combination {1, 0} in Table 7. Accordingly, the MAC control element for a power report includes a CIF CI, a TIF T, R fields, a P_{cmax,c}-T field, a P_{cmax,c}-G field, a P_{cmax,c}-P1 field to a P_{cmax,c}-Pn field.

FIG. 26 shows another example in which the MAC control element for a power report according to FIG. 24 is utilized. FIG. 25 shows the example in which a PSC is included in a PRCG and also in an IPCG (i.e., when the bit value of a CIF is 1).

Referring to FIG. 26, the structure of the MAC control element for a power report corresponds to the combination {1, 1} in Table 7. Accordingly, the MAC control element for a power report includes a CIF CI, a TIF T, R fields, a P_{cmax,c}-G field, a P_{cmax,c}-P1 field to a P_{cmax,c}-Pn field. The MAC control element for a power report does not include a P_{cmax,c}-T field. This to is because the P_{cmax,c}-T field has been absorbed by the P_{cmax,c}-G field.

(2) 1-Bit TIF+the Consecutive Structure

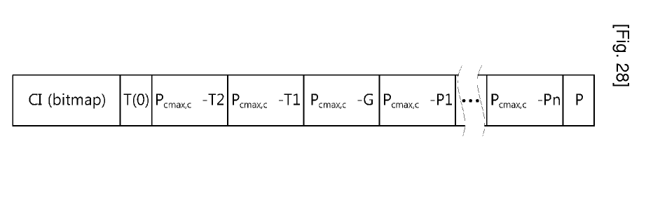

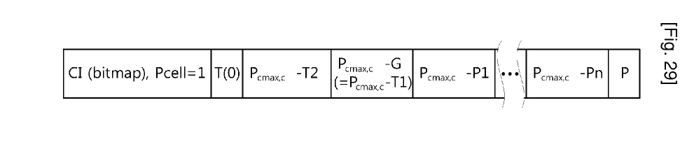

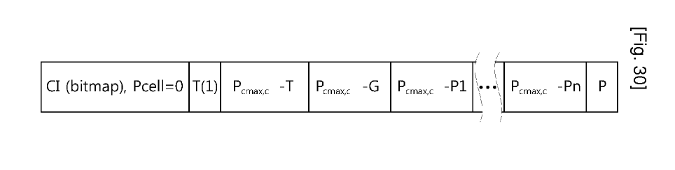

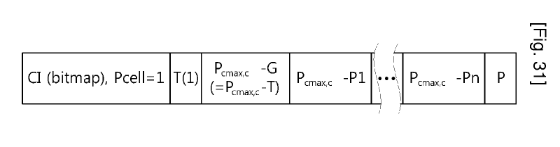

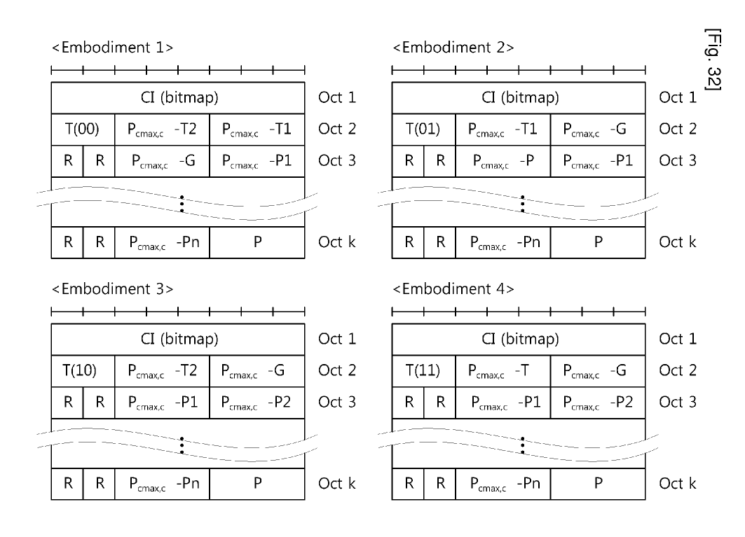

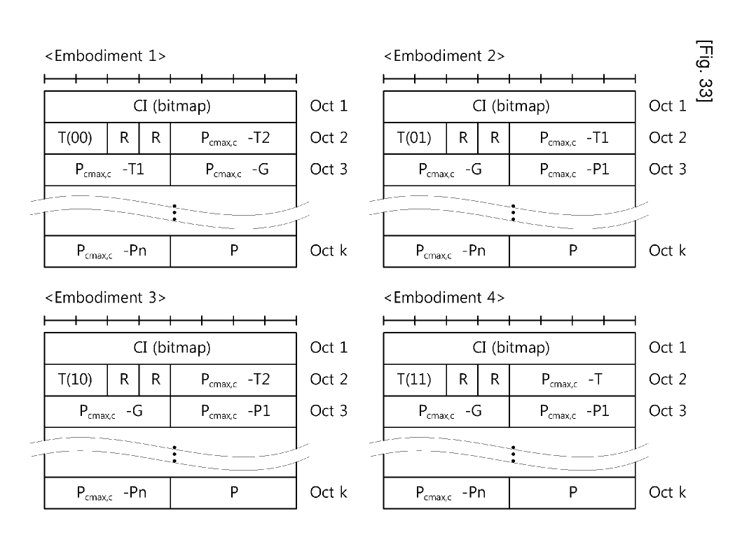

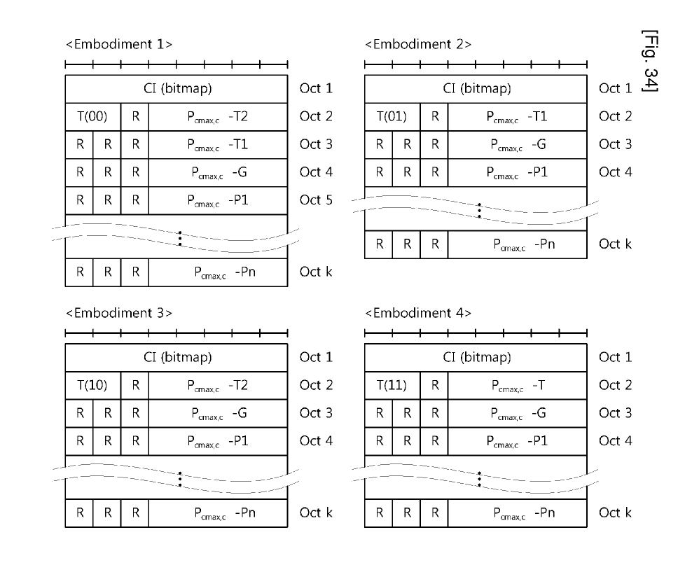

FIG. 27 shows the structure of an MAC control element for a power report according to still yet another example of the present invention. FIG. 27 shows an example in which a TIF value is 0 and a PSC is not included in a PRCG.

Referring to FIG. 27, the MAC control element for a power report includes a CIF CI, a P_{cmax,c}-G field having 6 bits, and a P_{cmax,c}-P field having 6 bits.

A first octet Oct 1 includes an 8-bit CIF. Since the bit of a CC0 (i.e., a PSC) has been set as a D field in the CIF, a P_{cmax,c}-T2 field, a P_{cmax,c}-T1 field, and a P_{cmax,c}-T field which are P_{cmax,c} fields regarding the PSC are not included in the MAC control element for a power report.

The P_{cmax,c}-G field and an individual P_{cmax,c} field are consecutively arranged over a second octet Oct 2 and a third octet Oct 3. An R field does not exist.

All bit values corresponding to a CC1, a CC2, and a CC3 of the CIF are 1. Accordingly, the CC1, the CC2, and the CC3 belong to an IPCG. All carrier maximum transmission power values regarding the CC1, the CC2, and the CC3 are identical with a maximum transmission power value indicated by the P_{cmax,c}-G field. Furthermore, a carrier maximum transmission power value regarding a CC4 is indicated by the individual P_{cmax,c} field.

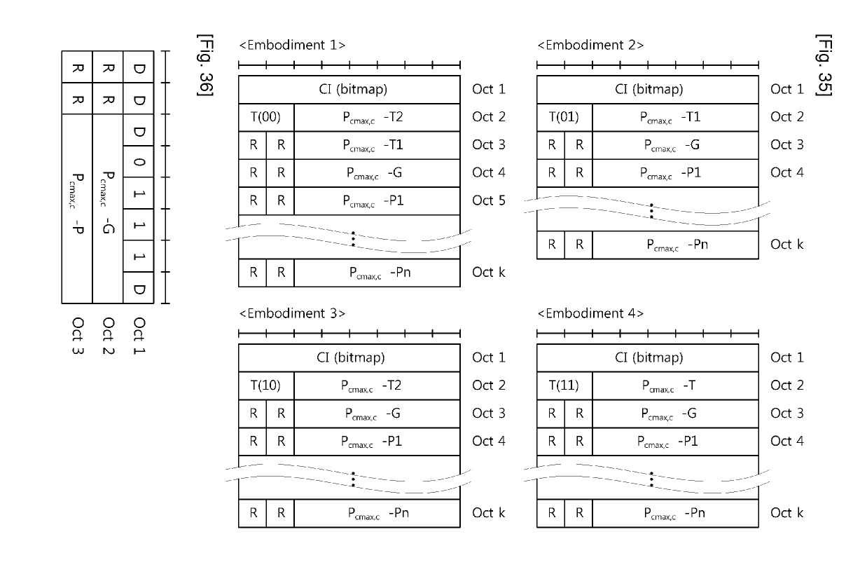

FIG. 28 shows the structure of an MAC control element for a power report according to further yet another example of the present invention. The structure of the MAC control element shown in FIG. 28 corresponds to the combination {0, 0} in Table 7.

Referring to FIG. 28, the MAC control element for a power report includes a CIF CI, a TIF T, a P_{cmax,c}-T2 field, a P_{cmax,c}-T1 field, a P_{cmax,c}-G field, a P_{cmax,c}-P1 field to a P_{cmax,c}-Pn field, and a padding bit P. Unlike the octet structure, there is no R field because the consecutive structure has no space between the fields.

FIG. 29 shows the structure of an MAC control element for a power report according to further yet another example of the present invention. The structure of the MAC control element shown in FIG. 29 corresponds to the combination {0, 1} in Table 7.

Referring to FIG. 29, the MAC control element for a power report includes a CIF CI, a TIF T, a P_{cmax,c}-T2 field, a P_{cmax,c}-G field, a P_{cmax,c}-P1 field to a P_{cmax,c}-Pn field, and a padding bit P. The P_{cmax,c}-T2 field is absorbed by the P_{cmax,c}-G field.

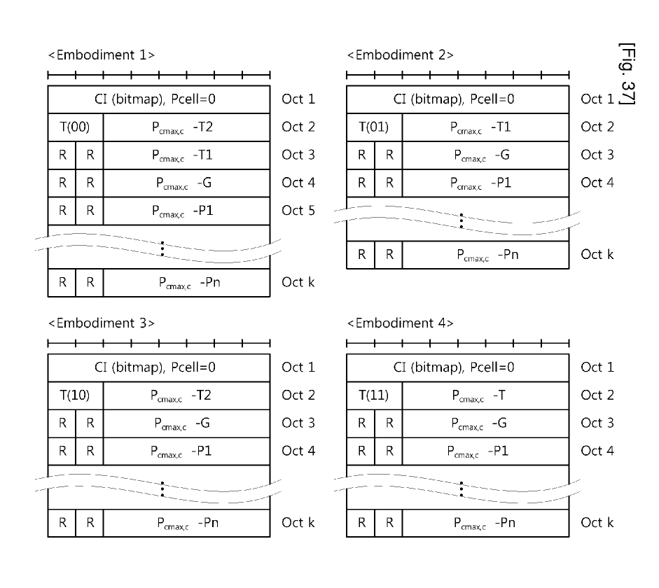

FIG. 30 shows the structure of an MAC control element for a power report according to still yet another example of the present invention. The structure of the MAC control element shown in FIG. 30 corresponds to the combination {1, 0} in Table 7.

Referring to FIG. 30, the MAC control element for a power report includes a CIF CI, a TIF T, a P_{cmax,c}-T field, a P_{cmax,c}-G field, a P_{cmax,c}-P1 field to a P_{cmax,c}-Pn field, and a padding bit P.

FIG. 31 shows the structure of an MAC control element for a power report according to still yet another example of the present invention. The structure of the MAC control element shown in FIG. 31 corresponds to the combination {1, 1} in Table 7.

Referring to FIG. 31, the MAC control element for a power report includes a CIF CI, a TIF T, a P_{cmax,c}-G field, a P_{cmax,c}-P1 field to a P_{cmax,c}-Pn field, and a padding bit P. The P_{cmax,c}-T field is absorbed by the P_{cmax,c}-G field.

(3) 2-bit TIF+Octet Structure

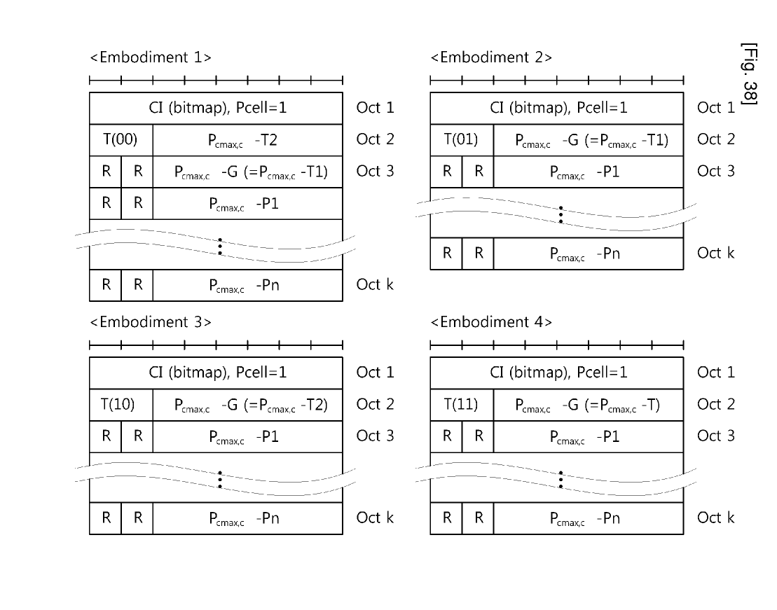

FIG. 32 shows the structures of MAC control elements for a power report according to still yet another example of the present invention. FIG. 32 shows an example in which a PSC is included in a PRCG, but not included in an IPCG (i.e., when the bit value of a CIF is 0).

Referring to FIG. 32, an embodiment 1, an embodiment 2, an embodiment 3, and an embodiment 4 show the structures of the MAC control elements for a power report when respective TIFs are 00, 01, 10, and 11. In all the embodiments, one octet may include a is maximum of two P_{cmax,c} fields because each P_{cmax,c} field has 3 bits. For example, a first octet Oct 1 in the embodiment 1 may include a TIF of 2 bits, a P_{cmax,c}-T2 field, and a P_{cmax,c}-T1 field. Each of the remaining subsequent octets may include two P_{cmax,c} fields.

In the embodiment 2, the MAC control element for a power report includes only the P_{cmax,c}-T1 field. In the embodiment 3, the MAC control element for a power report includes only the P_{cmax,c}-T2 field. Furthermore, in the embodiment 4, the MAC control element for a power report includes only the P_{cmax,c}-T field.

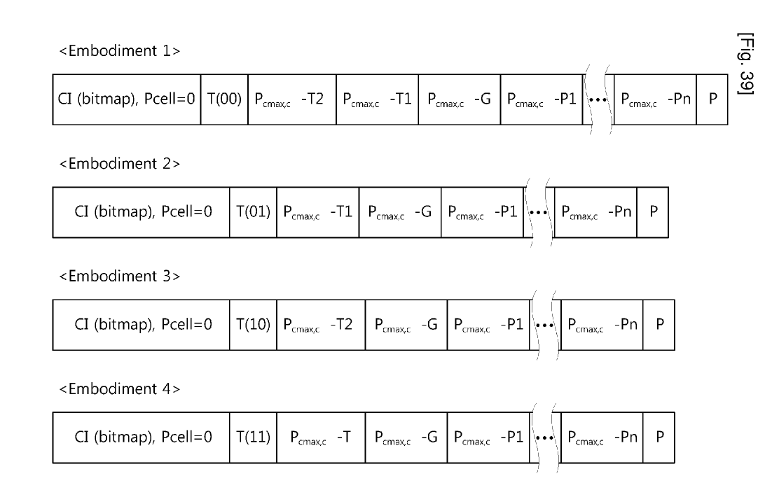

FIG. 33 shows the structures of MAC control elements for a power report according to further yet another example of the present invention. FIG. 33 shows an example in which a PSC is included in a PRCG, but not included in an IPCG (i.e., when the bit value of a CIF is 0).

Referring to FIG. 33, an embodiment 1, an embodiment 2, an embodiment 3, and an embodiment 4 show the structures of the MAC control elements for a power report when respective TIFs are 00, 01, 10, and 11. In all the embodiments, one octet may include a maximum of two P_{cmax,c} fields because 4 bits are included in each P_{cmax,c} field. For example, a first octet Oct 1 in the embodiment 1 may include a TIF of 2 bits, two R fields, and a P_{cmax,c}-T2 field. Each of the remaining subsequent octets may include two P_{cmax,c} fields.

In the embodiment 2, the MAC control element for a power report includes only the P_{cmax,c}-T1 field. In the embodiment 3, the MAC control element for a power report includes only the P_{cmax,c}-T2 field. Furthermore, in the embodiment 4, the MAC control element for a power report includes only the P_{cmax,c}-T field.

FIG. 34 shows the structures of MAC control elements for a power report according to still yet another example of the present invention. FIG. 34 shows an example in is which a PSC is included in a PRCG, but not included in an IPCG (i.e., when the bit value of a CIF is 0).

Referring to FIG. 34, an embodiment 1, an embodiment 2, an embodiment 3, and an embodiment 4 show the structures of the MAC control elements when respective TIFs are 00, 01, 10, and 11. In all the embodiments, one octet may include a maximum one P_{cmax,c} field because each P_{cmax,c} field includes 5 bits. For example, a first octet Oct 1 in the embodiment 1 may include a TIF of 2 bits, one R field, and a P_{cmax,c}-T2 field. Each of the remaining subsequent octets may include one P_{cmax,c} field.

In the embodiment 2, the MAC control element for a power report includes only a P_{cmax,c}-T1 field. In the embodiment 3, the MAC control element for a power report includes only a P_{cmax,c}-T2 field. Furthermore, in the embodiment 4, the MAC control element for a power report includes only a P_{cmax,c}-T field.

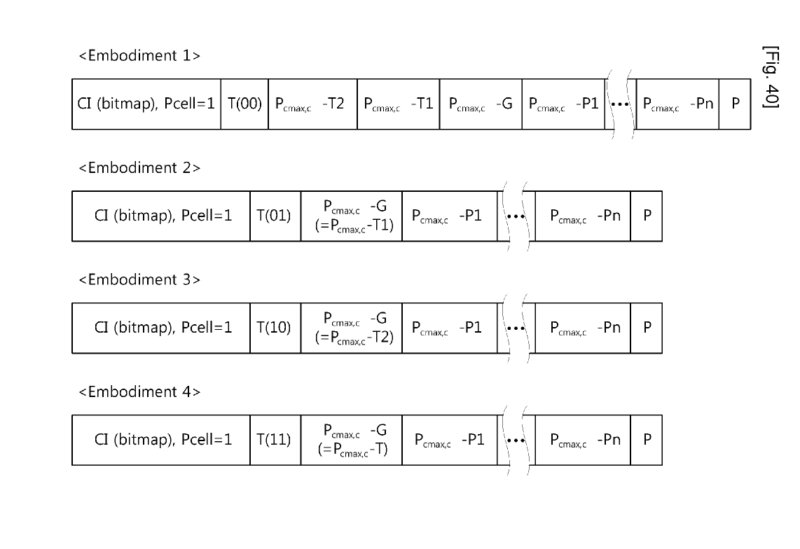

FIG. 35 shows the structures of MAC control elements for a power report according to still yet another example of the present invention. FIG. 35 shows an example in which a PSC is included in a PRCG, but not included in an IPCG (i.e., when the bit value of a CIF is 0).

Referring to FIG. 35, an embodiment 1, an embodiment 2, an embodiment 3, and an embodiment 4 show the structures of the MAC control elements for a power report when respective TIFs are 00, 01, 10, and 11. In all the embodiments, one octet may include a maximum one P_{cmax,c} field because each P_{cmax,c} field includes 6 bits. For example, a first octet Oct 1 in the embodiment 1 may include a TIF of 2 bits and a P_{cmax,c}-T2 field. Each of the remaining subsequent octets may include one P_{cmax,c} field.

In the embodiment 2, the MAC control element for a power report includes only a P_{cmax,c}-T1 field. In the embodiment 3, the MAC control element for a power report includes only a P_{cmax,c}-T2 field. Furthermore, in the embodiment 4, the MAC control element for a power report includes only a P_{cmax,c}-T field.

FIG. 36 shows an example in which the MAC control element for a power report according to FIG. 35 is utilized. FIG. 36 shows the example in which a PSC is not included in a PRCG.

Referring to FIG. 36, the MAC control element for a power report includes a plurality of R fields, a CIF CI having a bitmap form, a P_{cmax,c}-G field, and a P_{cmax,c} field.

A CIF within a first octet Oct 1 is DDD0111D. A D field indicates that what CC does not belong to the PRCG. It is assumed that a CC0, a CC1, a CC2 to a CC7 are sequentially mapped from a bit on the most right side to a bit on the most left side. The CC0, the CC5, the CC6, and the CC7 do not belong to the PRCG because they are the D fields. The PRCG includes only the CC1, the CC2, the CC3, and the CC4. Since the CC0 (i.e., the PSC) has been set as the D field, a P_{cmax,c}-T2 field and a P_{cmax,c}-T1 field (i.e., P_{cmax,c} fields regarding the PSC) are not included in the MAC control element for a power report. The classification of a type is meaningless because a carrier maximum transmission power regarding the PSC is not reported. Accordingly, the MAC control element for a power report does not include even a TIF.

All bit values corresponding to the CC1, the CC2, and the CC3 are 1. Accordingly, the CC1, the CC2, and the CC3 belong to an IPCG, and a second octet Oct 2 includes a P_{cmax,c}-G field. All carrier maximum transmission power values regarding the CC1, the CC2, and the CC3 are identical with a maximum transmission power value indicated by the P_{cmax,c}-G field. Furthermore, a maximum transmission power value regarding the CC4 is indicated by an individual P_{cmax,c} field within a third octet Oct 3.

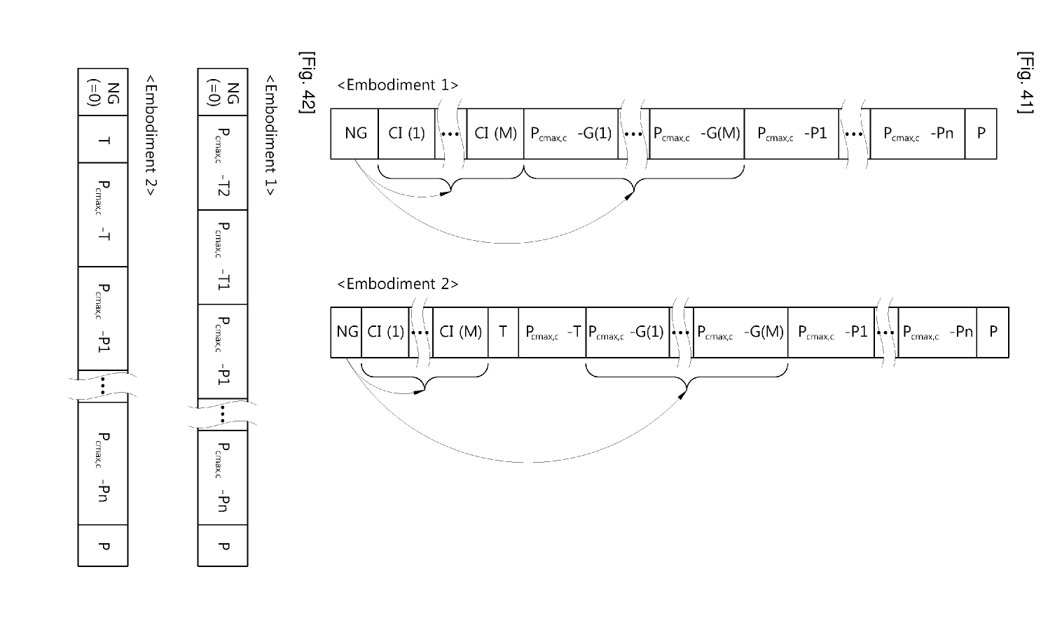

FIG. 37 shows another example in which the MAC control element for a power report according to FIG. 35 is utilized. FIG. 37 shows the example in which a PSC is included in a PRCG, but not included in an IPCG (i.e., when the bit value of a CIF is 0).

Referring to FIG. 37, an embodiment 1, an embodiment 2, an embodiment 3, and an embodiment 4 show the structures of the MAC control elements for a power report when the respective combinations are {00, 0}, {01, 0}, {10, 0}, and {11, 0} in Table 8. In all the embodiments, one octet may include one P_{cmax,c} field because each P_{cmax,c} field has 6 bits.

A detailed structure of the MAC control element for a power report according to each of the embodiments is the same as that of FIG. 35.

FIG. 38 shows yet another example in which the MAC control element for a power report according to FIG. 35 is utilized. FIG. 38 shows the example in which a PSC is included in a PRCG and also in an IPCG (i.e., when the bit value of a CIF is 1).

Referring to FIG. 38, an embodiment 1, an embodiment 2, an embodiment 3, and an embodiment 4 show the structures of the MAC control elements for a power report when the respective combinations in Table 8 are {00, 1}, {01, 1}, {10, 1}, and {11, 1}. In all the embodiments, one octet may include one P_{cmax,c} field because each P_{cmax,c} field has 6 bits.

In the embodiment 1, the MAC control element for a power report includes a CIF, a TIF, a P_{cmax,c}-T2 field, a P_{cmax,c}-G field, and a P_{cmax,c}-P1 field, . . . , a P_{cmax,c}-Pn field.

In the embodiments 2, 3, and 4, the MAC control element for a power report includes a CIF, a TIF, a P_{cmax,c}-G field, and a P_{cmax,c}-P1 field to a P_{cmax,c}-Pn field.

(4) 2 Bits the TIF+the Consecutive Structure

FIG. 39 shows the structures of MAC control elements for a power report according to still yet another example of the present invention. FIG. 39 shows an example in is which a PSC is included in a PRCG, but not included in an IPCG (i.e., when the bit value of a CIF is 0).

Referring to FIG. 39, embodiments 1, 2, 3, and 4 show the structures of the MAC control elements for a power report when the respective combinations in Table 8 are {00, 0}, {01, 0}, {10, 0}, and {11, 0}.

For example, in the embodiment 1, the MAC control element for a power report includes a CIF CI, a TIF T, a P_{cmax,c}-T2 field, a P_{cmax,c}-T1 field, a P_{cmax,c}-G field, a P_{cmax,c}-P1 field to a P_{cmax,c}-Pn field, and a padding bit P. Unlike the octet structure, the consecutive structure does not include an R field because there is no space between the fields.

In the remaining embodiments, the structure of the MAC control element for a power report includes at least one carrier maximum transmission power field in each of the combinations.

FIG. 40 shows the structures of MAC control elements for a power report according to still yet another example of the present invention. FIG. 40 shows an example in which a PSC is included in a PRCG and also included in an IPCG (i.e., when the bit value of a CIF is 1).

Referring to FIG. 40, embodiments 1, 2, 3, and 4 show the structures of the MAC control elements for a power report when the respective combinations in Table 8 are {00, 1}, {01, 1}, {10, 1}, and {11, 1}.

For example, in the embodiment 1, the MAC control element for a power report includes a CIF CI, a TIF T, a P_{cmax,c}-T2 field, a P_{cmax,c}-T1 field, a P_{cmax,c}-G field, P_{cmax,c}-P1 field to a P_{cmax,c}-Pn field, and a padding bit P.

On the other hand, in the embodiments 2, 3, and 4, the MAC control element for a is power report includes a CIF CI, a TIF T, a P_{cmax,c}-G field, a P_{cmax,c}-P1 field to a P_{cmax,c}-Pn field, and a padding bit P. Unlike the octet structure, the consecutive structure does not include an R field because there is no space between the fields. In the remaining embodiments, the structure of the MAC control element for a power report includes at least one carrier maximum transmission power field according to each of the combinations.

(5) Structure of an MAC Control Element for a Power Report when a Plurality of IPCGs Exist

A plurality of IPCGs may exist. For example, when a CC1 and a CC2 have the same carrier maximum transmission power, a first IPCG exists. Furthermore, when a CC3 and a CC4 have the same carrier maximum transmission power, a second IPCG exists. In order to indicate all the IPCGs, two CIFs and two P_{cmax,c}-G fields may be included in an MAC control element for a power report. The structure of an MAC control element for a power report when a plurality of IPCGs exists is described below.

FIG. 41 shows the structures of MAC control elements for a power report according to yet another example of the present invention. FIG. 41 shows the structures of the MAC control elements when a plurality of IPCGs exists.

Referring to FIG. 41, the MAC control element includes the Number of Group Field (NGF) and one or more CIF (CI(1) to CI(M)).

The number of a group (NG) field indicates the number of IPCGs. The number of a group (NG) field is placed within the MAC control element first of all. A maximum number of IPCGs which can be represented is changed according to the size of the number of a group (NG) field. For example, when the number of a group (NG) field is set to 2 bits, a maximum number of IPCGs may be 3. When the number of a group (NG) field value is ‘00’, it is indicates that there is no IPCG. When the number of a group (NG) field value is ‘10’, the number of IPCGs will be 2.

Furthermore, the number of bits of the number of a group (NG) field may be variably set. For example, if a maximum number of serving cells supportable by a mobile station is 8 (including a PCell), a maximum number of cell groups having the same power may be 4. Accordingly, the number of a group (NG) field may be set to 3 bits.

Here, the number of groups is defined by a system, and a maximum number of group that may be grouped, defined by the system, may be known to a mobile station through RRC signaling. In some embodiments, a mobile station may have the number of bits which is defined between systems within a maximum number of groups that may be grouped.

Each of a CIF and a P_{cmax,c}-G field is generated by the number indicated by the number of a group (NG) field value, and the CIF and the P_{cmax,c}-G field are sequentially arranged within the MAC control element for a power report. A 1:1 mapping relationship is established between the CIF and the P_{cmax,c}-G field. For example, a CIF CI(1) may be mapped to a P_{cmax,c}-G(1), and a CIF CI(M) may be mapped to a P_{cmax,c}-G(M) field.

The embodiment 1 shows the MAC control element not including a TIF T, and the embodiment 2 shows the MAC control element including a TIF T. In particular, in the embodiment 2, the MAC control element for a power report includes a TIF and a P_{cmax,c}-T field. A configuration of a carrier maximum transmission power field part may be changed according to the TIF value as in Table 7 or Table 8.

FIG. 42 shows the structures of MAC control elements for a power report according to still yet another example of the present invention. FIG. 42 shows the structures of the MAC control elements when any IPCG does not exist.

Referring to FIG. 42, the number of a group (NG) field value within the MAC control element for a power report is 0. When the number of a group (NG) field value is 0, it means that there is no IPCG. In other words, a CIF and a P_{cmax,c}-G field do not exist.

The MAC control element for a power report includes a P_{cmax,c}-T1 field and a P_{cmax,c}-T2 field without a TIF as in an embodiment 1 or includes a TIF and a P_{cmax,c}-T field as in an embodiment 2.

5. Procedure of Power Report

The structure of an MAC control element for a power report has a variety of formats as described above. A basic format is previously defined between a mobile station and a base station. For example, whether a TIF exists, the number of bits of a TIF, whether a CIF exists, the order of cell indices mapped to a CIF, and so on are previously known. On the other hand, an IPCG and a PRCG are not always fixed. Furthermore, the maximum transmission powers of the type 1 and the type 2 for the CC of a PSC may be the same or different according to circumstances. For example, the number of P_{cmax,c} fields included in the MAC control elements of FIGS. 18, 19, and 20 is different.

In view of the above situation, there is a need for an algorithm that enables a base station to efficiently detect a type of a P_{cmax,c} field and the number of P_{cmax,c} fields within an MAC control element. An algorithm for standardizing variable structures of MAC control elements in several formats and enabling a base station to detect the several standardized formats is provided.

Table 9 shows formats of MAC control elements for a power report.

TABLE 9

| | Bit value | | Number | |
|---|---|---|---|---|
| | of CIF | | of bits | |
| Format | of PSC | PRCG | of TIF | Information Structure |
| 1 | 0 | IPCG ≠ Null | 1 or 2 | octet/consecutive structure |
| 2 | 1 | | 1 or 2 | octet/consecutive structure |
| 3 | 0 | IPCG = Null | 1 or 2 | octet/consecutive structure |
| 4 | ‘D’ | IPCG = Null | 1 or 2 | octet/consecutive structure |

Referring to Table 9, the formats of the MAC control elements for a power report are classified into three kinds on the basis of the bit value of a CIF of a PSC. If the bit value of the CIF of the PSC is 0, the MAC control element for a power report has a first format. The MAC control element having the first format includes a CIF, a TIF, P_{cmax,c}-T1/P_{cmax,c}-T2 fields or a P_{cmax,c}-T field, a P_{cmax,c}-G field and/or a P_{cmax,c}-P field. If the carrier maximum transmission powers of all CCs belonging to the PRCG are identical with each other, the P_{cmax,c}-P field may be excluded. In some embodiments, if the carrier maximum transmission powers of all CCs belonging to the PRCG are different from each other, the P_{cmax,c}-G field may be excluded.

If the bit value of the CIF of the PSC is 1, the MAC control element for a power report has a second format. The MAC control element having the second format includes any one of a P_{cmax,c}-T1 field, a P_{cmax,c}-T2 field, and a P_{cmax,c}-T field, a CIF, a TIF, a P_{cmax,c}-G field and/or a P_{cmax,c}-P field. When the TIF is 1 bit, the TIF may not be included in the MAC control element having the second format. On the other hand, when the TIF is 2 bits, the TIF may be included or not included in the MAC control element having the second format. If the carrier maximum transmission powers of all CCs belonging to the PRCG are identical with each other, the P_{cmax,c}-P field may be excluded. In some embodiments, if the carrier maximum transmission powers of all CCs belonging to the PRCG are different from each other, the P_{cmax,c}-G field may be excluded.

If the bit value of the CIF of the PSC is 0 and the IPCG is Null, the MAC control element for a power report has a third format. The MAC control element having the third format includes a CIF, a TIF, P_{cmax,c}-T1/P_{cmax,c}-T2 fields or a P_{cmax,c}-T field, and at least one P_{cmax,c}-P field. When the IPCG is Null, it means that there is no cell belonging to the IPCG. If the carrier maximum transmission powers of all CCs belonging to the PRCG are identical with each other, the P_{cmax,c}-P field may be excluded. A mobile station can exclude the CIF from the MAC control element having the third format. Since the carrier maximum transmission power values do not have the same CC, the CIF may be excluded if the transmission of the CIF is unnecessarily redundant.

If the bit value of the CIF of the PSC is ‘D’ and the IPCG is Null, the MAC control element for a power report has a fourth format. The MAC control element having the fourth format includes only a CIF and a P_{cmax,c}-P field. In other words, a TIF, a P_{cmax,c}-T1, a P_{cmax,c}-T2, a P_{cmax,c}-T field, and a P_{cmax,c}-G field are not included. A mobile station can exclude the CIF from the MAC control element having the fourth format. Since the carrier maximum transmission power values do not have the same CC, the CIF may be excluded if the transmission of the CIF is unnecessarily redundant. Furthermore, since a PSC is not included in the PRCG, a P_{cmax,c}-T2 field and a P_{cmax,c}-T1 field are not included.

Although the four formats slightly differ in the number of bits of the TIF, the present invention is basically based on the four formats.

A method of interpreting an MAC control element for a power report according to an example of the present invention is described below. In this example, it is assumed that the octet structure or the consecutive structure has the structure of the MAC control element having the third format.

An embodiment 1 shows an example in which the MAC control element for a power report includes an MAC control element for a PHR (power headroom report) and an MAC control element for a carrier maximum transmission power report. The power headroom and the carrier maximum transmission power are correlated with each other in that they are used to assign proper uplink scheduling to all mobile stations. Accordingly, when a mobile station makes a power report, the carrier maximum transmission power, together with the power headroom, may be reported. On the other hand, an embodiment 2 shows an example in which the MAC control element for a power report includes only the MAC control element for the carrier maximum transmission power report.

Referring to the embodiment 1, the length of the MAC control element for the PHR is M. Furthermore, the length of the MAC control element for the carrier maximum transmission power report is N. Accordingly, the total length L of the MAC control element for a power report is M+N. Here, each of L, M, and N is an integer multiple of a byte. The MAC control element for the carrier maximum transmission power report may include a P_{cmax,c}-T2 field, a P_{cmax,c}-T1 field, a P_{cmax,c}-P1 field to a P_{cmax,c}-Pn field, and a padding bit. Here, a CI field or a P_{cmax,c}-G field may be included or the CI field or the P_{cmax,c}-G field may be included, but the P_{cmax,c}-T2 field and the P_{cmax,c}-T1 field may be excluded.

Referring to the embodiment 2, the MAC control element for the carrier to maximum transmission power report may include a P_{cmax,c}-T2 field, a P_{cmax,c}-T1 field, a P_{cmax,c}-P1 field to a P_{cmax,c}-Pn field, and a padding bit. Here, a CI field or a P_{cmax,c}-G field may be included or the CI field or the P_{cmax,c}-G field may be included, but the P_{cmax,c}-T2 field and the P_{cmax,c}-T1 field may be excluded. The total length L of the MAC control element for a power report is N.

It is assumed that the lengths of the P_{cmax,c}-T2 field, the P_{cmax,c}-T1 field, and the P_{cmax,c}-P field are S_{T2}, S_{T1}, and S_{P} and the total number of P_{cmax,c} fields (=the number of CCs belonging to a PRCG) is N_{P}.

(1) First, it is assumed that a PSC belongs to the PRCG. If an MAC control element is the consecutive structure, a base station interprets the MAC control element as having the third format, if the following equation is established, and interprets the MAC control element as having the first or second format if the following equation is not established.

$$N ≡ ⌈ \frac{{S}_{T 2} + {S}_{T 1} + {S}_{P} \times ( {N}_{P} - 1 )}{8} ⌉ \qquad Equation 7$$

Meanwhile, if the MAC control element is the octet structure, an interpretation method is divided into two kinds according to the number of bits of a P_{cmax,c} field.

First, if the P_{cmax,c} field is 3 bits or 4 bits, two P_{cmax,c} fields may exist in one octet. In this case a base station interprets the MAC control element as having the third format, if the following equation is established, and interprets the MAC control element as having the first format or the second format if the following equation is not established.

$$N ≡ ⌈ \frac{( {N}_{P} + 1 )}{2} ⌉ \qquad Equation 8$$

Next, if the P_{cmax,c} field is 5 bits or 6 bits, one P_{cmax,c} field may exist in one octet. In this case a base station interprets the MAC control element as having the third format, if the following equation is established, and interprets the MAC control elements as having the first format or the second format if the following equation is not established.

N≡N_{P}+1 Equation 9

Since the base station already knows the value of N_{P}, and the values of S_{T}2, S_{T1}, and Sₚ are already determined. If Equation 7 to Equation 9 below are established for N obtained from L, it means that the MAC control element does not include a CIF and a P_{cmax,c}-G field. Accordingly, it can be seen that the MAC control element has the third format.

(2) Next, it is assumed that the PSC does not belong to the PRCG.

If an MAC control element has the consecutive structure, a base station interprets the MAC control element as having the fourth format, if the following equation is established, and interprets the MAC control element as having the first format or the second format if the following equation is not established.

$$N ≡ ⌈ \frac{{S}_{P} \times ( {N}_{P} - 1 )}{8} ⌉ \qquad Equation 10$$

Meanwhile, if an MAC control element has the octet structure, an interpretation method is divided into two kinds according to the number of bits of a P_{cmax,c} field.

First, if the P_{cmax,c} field is 3 bits or 4 bits, two P_{cmax,c} fields may exist in one octet. In this case, a base station interprets the MAC control element for a power report as having the fourth format, if the following equation is established, and interprets the MAC control element for a power report as having the first format or the second format if the following equation is not established.

$$N ≡ ⌈ \frac{( {N}_{P} - 1 )}{2} ⌉ \qquad Equation 11$$

Next, if the P_{cmax,c} field is 5 bits or 6 bits, one P_{cmax,c} field may exist in one octet. In this case a base station interprets the MAC control element for a power report as having the fourth format, if the following equation is established, and interprets the MAC control element as having the first format or the second format if the following equation is not established.

Equation 12

N≡N_{P}−1

A base station already knows the value of N_{P}, and the value of S_{P} is already determined. If Equation 10 to Equation 12 are established in relation to N obtained from L, it means that the MAC control element does not include a CIF and a P_{cmax,c}-G field. Accordingly, it can be seen that the MAC control element has the third format or the fourth format.

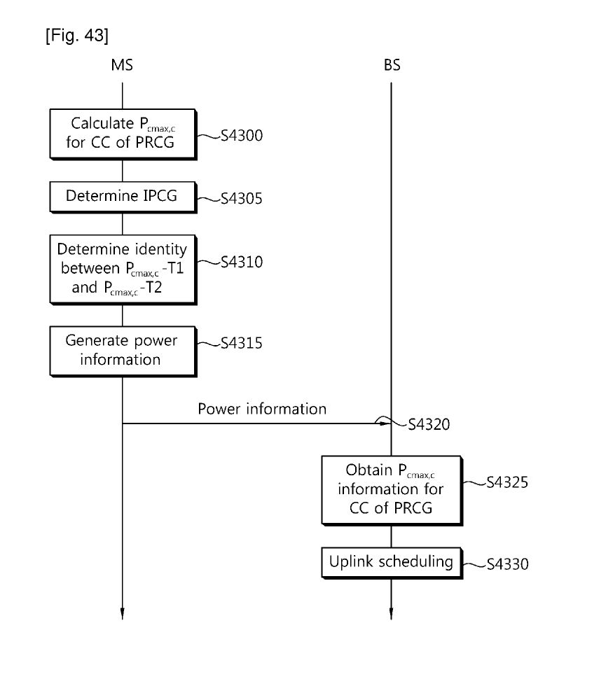

FIG. 43 is a flowchart illustrating a method of transmitting power information according to an example of the present invention.

Referring to FIG. 43, a mobile station (MS) calculates a carrier maximum transmission power P_{cmax,c} for each of the CCs, belonging to a PRCG (power report cell group), at step S4300. A method of calculating the carrier maximum transmission power may be performed according to, for example, Equation 1 to Equation 6. Information about the PRCG may be previously known between the mobile station and a base station, the mobile station may have transmitted the information to the base station separately, or the base station may have informed the mobile station of the information. The carrier maximum transmission power may is be represented on the basis of a range mapping table, such as Table 1 to Table 4.

The mobile station determines an IPCG (identical power cell group) at step S4305. At this step, the mobile station may determine CCs having the same carrier maximum transmission power or having a difference of a critical value or less between their carrier maximum transmission powers, from among the CCs belonging to the PRCG, as the IPCG.

The mobile station determines identity between a type 1 maximum transmission power P_{cmax,c}-T1 and a type 2 maximum transmission power P_{cmax,c}-T2 for the CCs of a PSC at step S4310. This corresponds to a case where the PSC belongs to the PRCG. Accordingly, if the PSC does not belong to the PRCG, the step S4310 may be omitted. This is because the carrier maximum transmission power for each of the CCs of the PSC needs not to be reported and power needs not to be calculated.

The mobile station generates power information at step S4315. The power information may be higher layer signaling, such as an MAC message or an RRC message, or may be physical layer signaling. The power information may also refer to an MAC control element for a power report. In some embodiments, the power information may refer to an MAC control element for, in particular, a carrier maximum transmission power report. In some embodiments, the power information may refer to both an MAC control element for a PHR and an MAC control element for a carrier maximum transmission power report. In some embodiments, the power information may refer to a carrier maximum transmission power field. The power information may include a CIF indicating CCs belonging to an IPCG. The power information may further include a TIF indicating identity between a type 1 maximum transmission power and a type 2 maximum transmission power for the CCs of a PSC.

The mobile station transmits the power information to a base station (BS) at step S4320.

The base station obtains a carrier maximum transmission power information for each of the CCs of the PRCG on the basis of the power information at step S4325. In order to obtain the carrier maximum transmission power value of each CC on the basis of the power information, the power information has to be interpreted. The above-described interpretation method may be used.

The base station performs uplink scheduling for each CC on the basis of the obtained carrier maximum transmission power value at step S4330. Furthermore, the base station may generate an uplink grant, such as Table 10, and inform the mobile station of the uplink grant.

Table 10
Flag for format0/format1A differentiation—1 bit, where value 0 indicates format 0 and, value 1 indicates format 1A
Frequency hopping flag—1 bit
Resource block assignment and hopping resource allocation—┌log₂(N_{RB}^{UL}(N_{RB}^{UL}+1)/2)┐ bits
   For PUSCH hopping:
      N_{UL}_{_{—}}ₕₒₚ MSB bits are used to obtain the value of ñ_{PRB}(i)
      (┌log₂(N_{RB}^{UL}(N_{RB}^{UL}+1)/2)┐−N_{UL}_{_{—}}ₕₒₚ) bits provide the resource allocation of the first slot in the subframe
   For non-hopping PUSCH,

(┌log₂(N_{RB}^{UL}(N_{RB}^{UL}+1)/2)┐ bits provide the resource allocation in the UL subframe
Modulation and coding scheme and redundancy version—5 bits
New data indicator—1 bit
TPC command for scheduled PUSCH—2 bits
Cyclic shift for DM RS—3 bits
UL index—2 bits (this field is present only for TDD operation with uplink-downlink configuration 0)
   Downlink Assignment Index (DAI)—2 bits (this field is present only for TDD operation with uplink-downlink configurations 1-6)
CQI request—1 bit
Carrier Index Field (CIF)—3 bits(this field is present only for Carrier Aggregation)

The uplink grant is information corresponding to the format 0 of downlink control information (DCI) transmitted on a PDCCH, and it includes pieces of information, such as an RB, a modulation and coding scheme (MCS), and TPC.

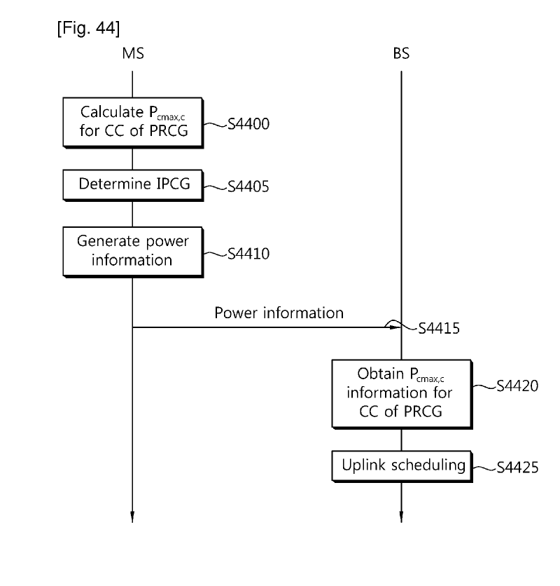

FIG. 44 is a flowchart illustrating a method of transmitting power information according to an example of the present invention.

Referring to FIG. 44, a mobile station calculates a carrier maximum transmission power P_{cmax,c} for each of CCs belonging to a PRCG at step S4400. A method of calculating the carrier maximum transmission power may be performed according to, for example, Equation 1 to Equation 6. Information about the PRCG may be previously known between the mobile station and a base station, the mobile station may have transmitted the information to the base station separately, or the base station may have informed the mobile station of the information. The carrier maximum transmission power may be represented on the basis of a range mapping table, such as Table 1 to Table 4.

The mobile station determines an IPCG at step S4405. At this step, the mobile station may determine CCs having the same carrier maximum transmission power or having a difference of a critical value or less between their carrier maximum transmission powers, from among the CCs belonging to the PRCG, as the IPCG.

The mobile station generates power information at step S4410. The power information may be higher layer signaling, such as an MAC message or an RRC message, or is may be physical layer signaling. The power information may also refer to an MAC control element for a power report. In some embodiments, the power information may refer to an MAC control element for, in particular, a carrier maximum transmission power report. In some embodiments, the power information may refer to both an MAC control element for a PHR and an MAC control element for a carrier maximum transmission power report. In some embodiments, the power information may refer to a carrier maximum transmission power field. The power information may include a CIF indicating CCs belonging to an IPCG.

The mobile station transmits the power information to a base station at step S4415.

The base station obtains carrier maximum transmission power information from each of the CCs of the PRCG on the basis of the power information at step S4420. In order to obtain the carrier maximum transmission power value of each CC from the power information, the power information has to be interpreted. The above-described interpretation method may be used.

The base station performs uplink scheduling for each CC on the basis of the obtained carrier maximum transmission power value at step S4425. Furthermore, the base station may generate an uplink grant, such as Table 10, and inform the mobile station of the uplink grant.

The uplink grant is information corresponding to the format 0 of downlink control information (DCI) transmitted on a PDCCH, and it includes pieces of information, such as an RB, a modulation and coding scheme (MCS), and TPC.

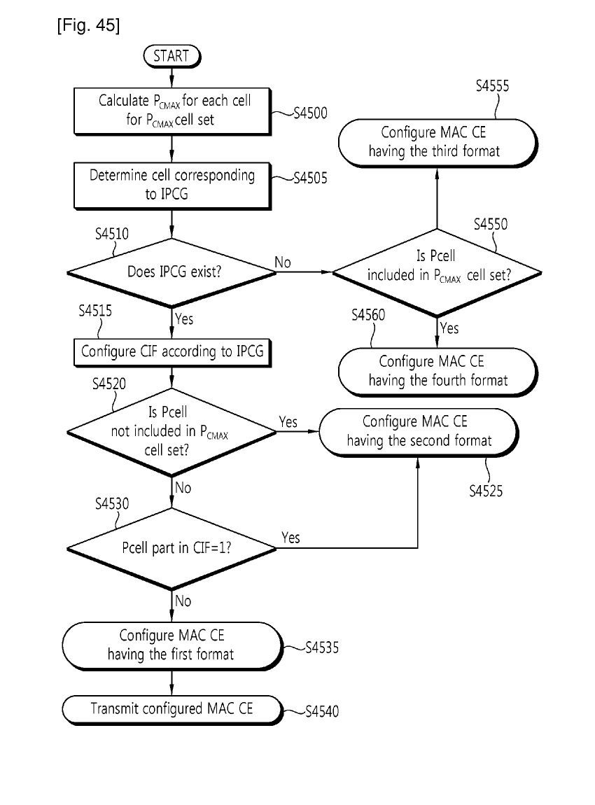

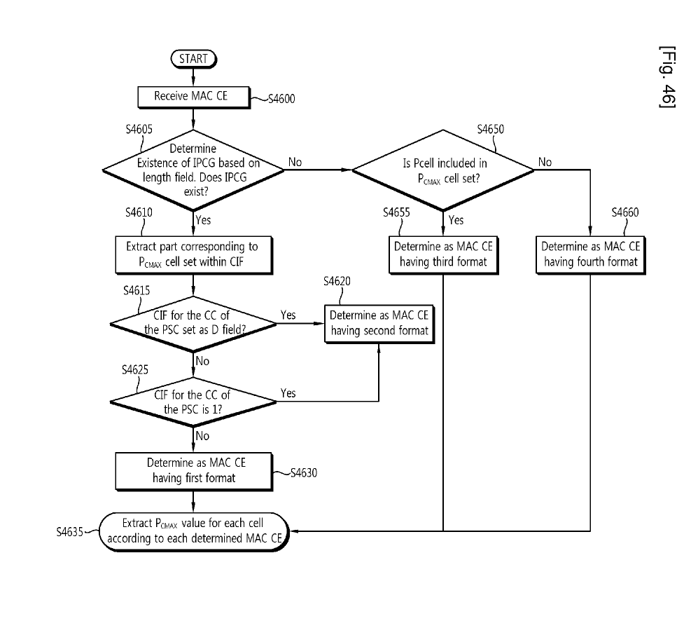

FIG. 45 is a flowchart illustrating a method of a mobile station transmitting power information according to an example of the present invention.

Referring to FIG. 45, the mobile station calculates a maximum transmission power P_{cmax,c} for each of CCs belonging to a PRCG at step S4500. A method of calculating the carrier maximum transmission power may be performed according to, for example, Equation 1 to Equation 6. Information about the PRCG may be previously known between the mobile station and a base station, the mobile station may have transmitted the information to the base station separately, or the base station may have informed the mobile station of the information. The carrier maximum transmission power may be represented on the basis of a range mapping table, such as Table 1 to Table 4.

The mobile station determines a cell corresponding to IPCG at step S4505. And, the mobile station determines whether there is an IPCG at step S4510. If, as a result of the determination, any CC is determined not to exist in the IPCG, the mobile station determines a PSC is included in the PRCG at step S4550. If, as a result of the determination, the PSC is determined to be included in the PRCG, the mobile station configures an MAC control element having the third format at step S4555. On the other hand, if, as a result of the determination, the PSC is determined not to be included in the PRCG, the mobile station configures an MAC control element having the fourth format at step S4560. Here, the MAC control element of the fourth format does not include a P_{cmax,c}-T2 field, a P_{cmax,c}-T1 field, and a P_{cmax,c}-G field.

If, as a result of the determination, two or more CCs exist in the IPCG, the mobile station configures a CIF at step S4515. The CIF has a bitmap form, and the mobile station may configure the CIF by setting a bit value, mapped to each CC, to 1 or 0.

The mobile station determines whether the CC of the PSC belongs to the PRCG at step S4520. Here, the mobile station may determine whether a bit corresponding to the CC of is the PSC has been set as a D field in the CIF. If, as a result of the determination, the CC of the PSC is determined not to belong to the PRCG, the mobile station configures an MAC control element having the second format other than a P_{cmax,c}-G field at step S4525.

If, as a result of the determination, the CC of the PSC is determined to belong to the PRCG, the mobile station determines whether a CIF regarding the CC of the PSC indicates 1 at step S4530. If, as a result of the determination, the CIF regarding the CC of the PSC is determined to indicate 1, the mobile station configures an MAC control element having the second format again at step S4525.

If, as a result of the determination, the CIF regarding the CC of the PSC is determined to indicate 0, however, the mobile station configures an MAC control element having the first format at step S4535. Next, the mobile station transmits the configured MAC control element to a base station at step S4540.

FIG. 46 is a flowchart illustrating a method of a base station receiving power information according to an example of the present invention.

Referring to FIG. 46, the base station receives an MAC control element from a mobile station at step S4600. The base station determines whether there is a CC in an IPCG at step S4605. If, as a result of the determination, a CC is determined not to exist in the IPCG, the base station determines whether a PSC is included in the PRCG at step S4650. If, as a result of the determination, the PSC is determined to be included in the PRCG, the base station determines the received MAC control element as an MAC control element having the third format at step S4655. If, as a result of the determination, the PSC is determined not to be included in the PRCG, however, the base station determines the received MAC control element as an MAC control element having the fourth format at step S4660. Here, the MAC control is element of the fourth format does not include a P_{cmax,c}-T2 field, a P_{cmax,c}-T1 field, and a P_{cmax,c}-G field.

If, as a result of the determination, at least one CC is determined to exist in the IPCG, however, the base station extracts a part corresponding to P_{CMAX} cell set within CI field at step S4610, and, determines whether a CIF for the CC of the PSC has been set as a D field at step S4615.

If, as a result of the determination, a CIF for the CC of the PSC is determined to have been set as a D field, the base station determines the MAC control element as an MAC control element having the second format at step S4620. If, as a result of the determination, a CIF for the CC of the PSC is determined not to have been set as a D field, the base station determines whether the CIF for the CC of the PSC is 1 at step S4625.

If, as a result of the determination, the CIF for the CC of the PSC is determined to be 1, the base station determines the MAC control element as an MAC control element having the second format at step S4620. If, as a result of the determination, the CIF for the CC of the PSC is determined to be 0, however, the base station determines the MAC control element as an MAC control element having the first format at step S4630.

The base station obtains a carrier maximum transmission power value for the CC belonging to the PRCG by successfully interpreting the MAC control element at step S4635.

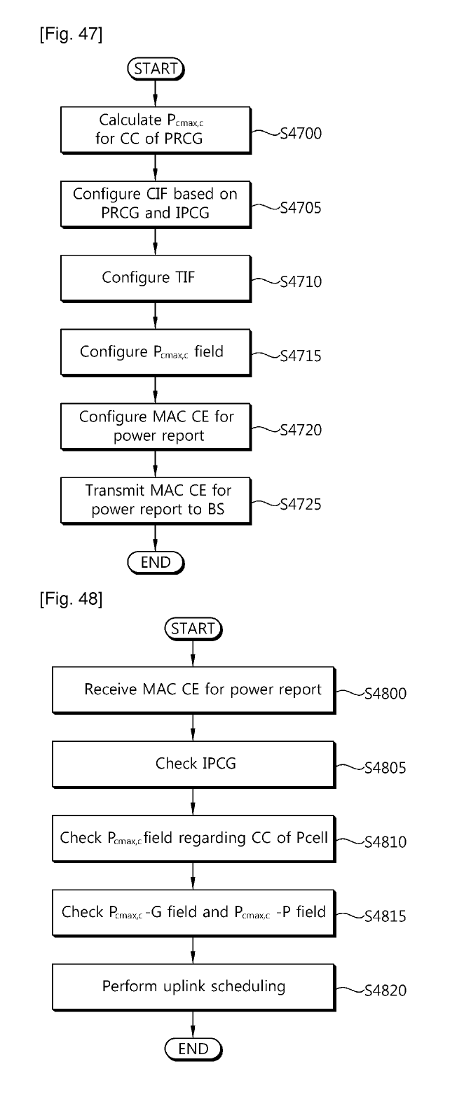

FIG. 47 is a flowchart illustrating a method of a mobile station transmitting power information according to another example of the present invention.

Referring to FIG. 47, the mobile station calculates a carrier maximum transmission power P_{cmax,c} for each of CCs belonging to a PRCG at step S4700. A method of calculating the carrier maximum transmission power may be performed according to, for example, Equation 1 to Equation 6. Information about the PRCG may be previously known between the mobile station and a base station, the mobile station may have transmitted the information to the base station separately, or the base station may have informed the mobile station of the information. The carrier maximum transmission power may be represented on the basis of a range mapping table, such as Table 1 to Table 4.

The mobile station configures a CIF on the basis of the PRCG and an IPCG at step S4705. The IPCG may exist when carrier maximum transmission powers for at least two CCs have identity. An example of a method of configuring the CIF is shown in the paragraph ‘(3) Type of Field’.

The mobile station configures a TIF at step S4710. To this end, the mobile station first determines whether a PSC belongs to the PRCG. If, as a result of the determination, the PSC is determined to belong to the PRCG, the mobile station determines whether a type 1 maximum transmission power and a type 2 maximum transmission power regarding the PSC are identical with each other. For example, if the type 1 maximum transmission power and the type 2 maximum transmission power are identical with each other, the TIF of 1 bit indicates 1. Furthermore, if the type 1 maximum transmission power and the type 2 maximum transmission power are different from each other, the TIF of 1 bit indicates 0.

The mobile station configures a carrier maximum transmission power field at step S4715. Types of the carrier maximum transmission power field are listed in Table 6. Meanwhile, the types and number of the carrier maximum transmission power fields are determined by the indications of the CIF and the TIF. In particular, the number of carrier maximum transmission power fields within an MAC control element for a power report may depend on the bit value of a CIF corresponding to a PSC. For example, if the bit value of a CIF corresponding to a PSC is ‘D’, a P_{cmax,c}-T1 field, a P_{cmax,c}-T2 field, and a P_{cmax,c}-T field are not included in an MAC control element for a power report. Furthermore, if the bit value of a CIF corresponding to a PSC is 1, an MAC control element for a power report includes only any one of a P_{cmax,c}-T1 field, a P_{cmax,c}-T2 field, and a P_{cmax,c}-T field. Furthermore, if the bit value of a CIF corresponding to a PSC is 0, an MAC control element for a power report may include a P_{cmax,c}-T1 field and a P_{cmax,c}-T2 field or may include a P_{cmax,c}-T field according to a TIF value.

The mobile station configures an MAC control element for a power report at step S4720. The MAC control element for a power report includes a CIF, a TIF, and at least one carrier maximum transmission power field. In some embodiments, the MAC control element for a power report may include only any one of the CIF, the TIF, and the at least one carrier maximum transmission power field. An example of the order of the fields arranged within the MAC control element is shown in Table 6.

The mobile station transmits the MAC control element for a power report to a base station at step S4725. The MAC control element for a power report is included in an MAC PDU, the MAC PDU includes at least one MAC sub-header, and the MAC sub-header includes an LCID field to identify the MAC control element for a power report.

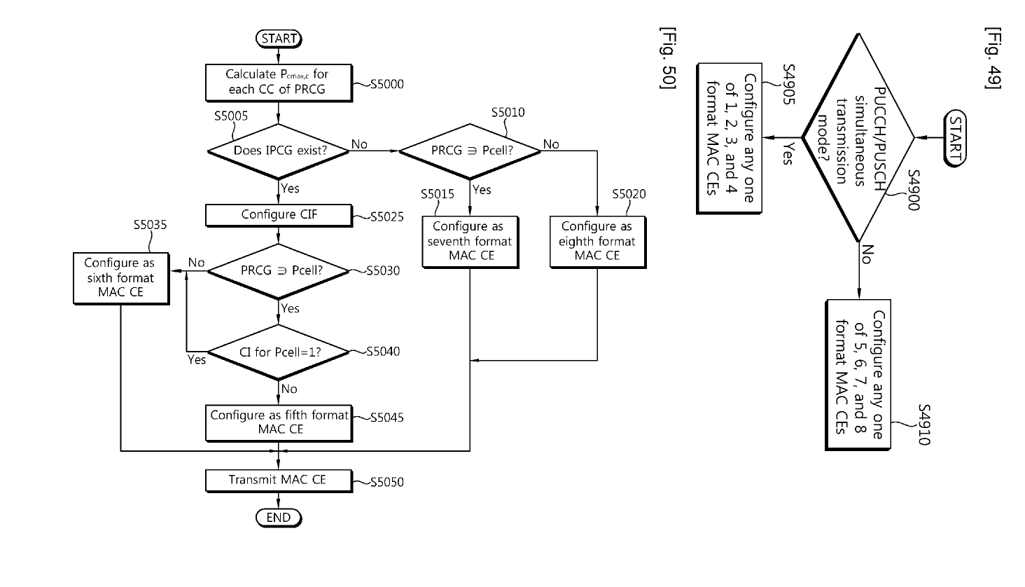

FIG. 48 is a flowchart illustrating a method of a base station receiving power information according to another example of the present invention.

Referring to FIG. 48, the base station receives an MAC control element (CE) for a power report from a mobile station at step S4800. The base station analyzes the MAC control element according to the following order.

The base station checks an IPCG on the basis of a CIF at step S4805. The bit values of the cell indicator fields of serving cells belonging to the IPCG are set to 1. For example, if the CIF is 01000100, a CC2 and a CC6 belong to the IPCG.

Next, the base station checks a carrier maximum transmission power field (P_{cmax,c}) (i.e., a type 1 maximum transmission power field (P_{cmax,c}-T1) and a type 2 maximum transmission power field (P_{cmax,c}-T2) or a common maximum transmission power field (P_{cmax,c}-T)) regarding the CC of a PSC on the basis of a TIF and the bit value of a CIF regarding a PSC at step S4810. A check procedure of the base station is as follows. Here, it is assumed that the bit value of a CIF regarding the PSC is 0, for the sake of convenience.

For example, it is assumed that the TIF is 1 bit. If the TIF value is 0, the MAC control element includes both a P_{cmax,c}-T1 field and a P_{cmax,c}-T2 field. If the TIF value is 1, however, the MAC control element includes only the P_{cmax,c}-T field.

For another example, it is assumed that the TIF is 2 bits. If the TIF value is 00, the MAC control element includes both a P_{cmax,c}-T1 field and a P_{cmax,c}-T2 field. If the TIF value is 01, the MAC control element includes only the P_{cmax,c}-T1 field. If the TIF value is 10, the MAC control element includes only the P_{cmax,c}-T2 field. If the TIF value is 11, the MAC control element includes only the P_{cmax,c}-T field.

The base station checks the P_{cmax,c}-G field and the P_{cmax,c}-P field on the basis of the IPCG at step S4815. Maximum transmission powers indicated by the P_{cmax,c}-G field are listed in Table 1 to Table 4. They become maximum transmission power values for all CCs belonging to the IPCG. Carrier maximum transmission powers regarding the CCs of the remaining serving cells not belonging to the IPCG can be known through individual P_{cmax,c}-P fields.

In this manner, the base station can obtain maximum transmission power values regarding all the CCs belonging to the PRCG. The base station performs uplink scheduling on is the basis of the obtained carrier maximum transmission power value for each of the CCs at step S4820.

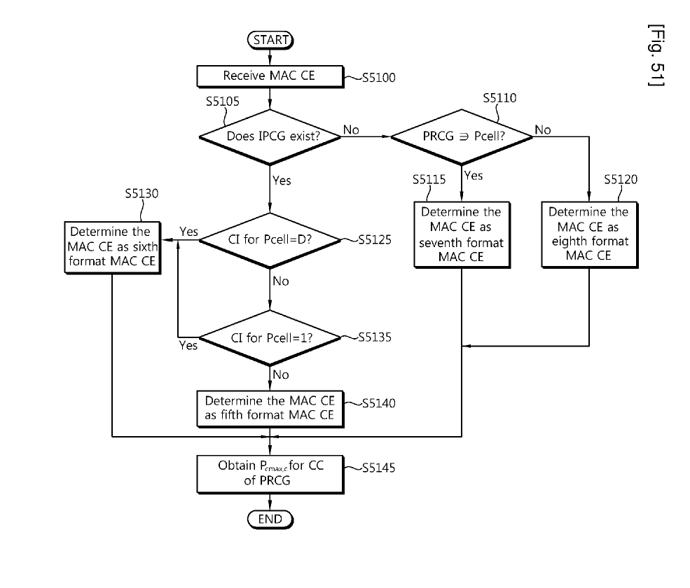

Meanwhile, FIG. 49 is a diagram showing a flowchart of determining a format in which power information is transmitted by taking the simultaneous transmission of a PUCCH and a PUSCH into consideration according to an example of the present invention. FIG. 49 shows selection according to the setting of the PUCCH/PUSCH simultaneous transmission mode.

Referring to FIG. 49, in uplink transmission, there may be a transmission mode in which a PUSCH and a PUCCH can be transmitted at the same time and a transmission mode in which a PUSCH and a PUCCH transmission cannot be transmitted at the same time. The uplink transmission modes may be differently set according to higher signaling (RRC signaling).

A mobile station determines whether a mode is a mode in which a PUSCH and a PUCCH can be transmitted at the same time at step S4900. If, as a result of the determination, the PUSCH and the PUCCH can be transmitted at the same time, a P_{cmax,c}-T1 field or a P_{cmax,c}-T2 field may appear. If, as a result of the determination, the PUSCH and the PUCCH cannot be transmitted at the same time, the P_{cmax,c}-T2 field cannot appear. In other words, the value of the P_{cmax,c}-T2 is not transmitted.

An MAC control element for a power report when the mode in which the PUSCH and the PUCCH cannot be transmitted at the same time is set is additionally classified into four formats.

For example, an MAC control element including a P_{cmax,c} field other than all kinds of P_{cmax,c}-T2 fields is called an MAC control element having a fifth format. That is, the MAC control element of the fifth format includes all a CIF, a P_{cmax,c}-T1 field, a P_{cmax,c}-G field, and a P_{cmax,c}-P field. This corresponds to a case where a CC0 does not belong to an IPCG, a CC belonging to the IPCG is at least two, and a CC not belonging to the IPCG is at least one. Of course, if the carrier maximum transmission powers of all the CCs belonging to the PRCG are identical with each other, the P_{cmax,c}-P field may be excluded.

For another example, an MAC control element, including only a CIF, a P_{cmax,c}-G field, and P_{cmax,c}-P field, is called an MAC control element having a sixth format. This corresponds to a case where a CC0 belongs to an IPCG, a CC belonging to the IPCG is at least two, and a CC not belonging to the IPCG is at least one. Of course, if the carrier maximum transmission powers of all the CCs belonging to the PRCG are identical with each other, the P_{cmax,c}-P field may be excluded. Here, if a Pcell (primary serving cell) belongs to the PRCG and belongs to the IPCG, a value corresponding to the P_{cmax,c}-T1 field is replaced with a value corresponding to the P_{cmax,c}-G field. However, if the Pcell does not belong to the PRCG, there is no value corresponding to the P_{cmax,c}-T1 field.

For yet another example, an MAC control element, including a P_{cmax,c}-T1 field and a P_{cmax,c}-P field, is called an MAC control element having a seventh format. The MAC control element of the seventh format does not include a P_{cmax,c}-G field. This corresponds to a case where an IPCG is Null (i.e., there is no CC belonging to the IPCG because carrier maximum transmission powers are different in all the CCs). A mobile station may exclude a CIF from the MAC control element of the third format. This is because, since CCs having the same carrier maximum transmission power value do not exist, the transmission of the CIF is unnecessarily redundant. Accordingly, the MAC control element of the seventh format does not include the CIF.

Both the MAC control element of the fifth format and the MAC control element is of the sixth format include the CIF, but the MAC control element of the seventh format does not include the CIF. The P_{cmax,c}-T1 field not the CIF is placed in the first field of the MAC control element of the seventh format. A base station must have a special algorithm for interpreting the first field because of this difference. The base station can determine whether an MAC control element is the MAC control element having the fifth or sixth format or the MAC control element having the seventh format using the algorithm. If additional control information indicating whether the first field is a CIF is separately transmitted, this may be an unnecessary waste.

For yet another example, an MAC control element including a P_{cmax,c}-P field is called an MAC control element having an eighth format. The MAC control element of the eighth format does not include a P_{cmax,c}-T2 field, a P_{cmax,c}-T1 field, and a P_{cmax,c}-G field. This corresponds to a case where, when an IPCG is Null, there is no CC belonging to the IPCG because all carrier maximum transmission powers are different in CCs. A mobile station may exclude a CIF from the MAC control element of the eighth format. This is because, since there is no carrier maximum transmission power value having the same CC, the transmission of the CIF may be unnecessarily redundant. Accordingly, the MAC control element of the eighth format does not include the CIF. Furthermore, since a PSC is not included in a PRCG, a P_{cmax,c}-T1 field is also not included.

Furthermore, in determining a P_{cmax,c} value, although a PUSCH and a PUCCH are transmitted at the same time, there may be one P_{cmax,c} value for a PSC. This is because a P_{cmax,c}-T1 value and a P_{cmax,c}-T2 for the PSC which are actually calculated may be identically calculated. Here, the P_{cmax,c}-T1 field and the P_{cmax,c}-T2 field may be configured into one P_{cmax,c} field.

Furthermore, in determining a P_{cmax,c} value, if the P_{cmax,c} value is not transmitted is for virtual resources, only the P_{cmax,c}-T1 field may exist because the P_{cmax,c}-T2 value is not transmitted when only the PUSCH is transmitted in a Pcell. Accordingly, one P_{cmax,c} field for a PSC may be configured.

Furthermore, in determining a P_{cmax,c} value, if the P_{cmax,c} value is not transmitted for virtual resources, only the P_{cmax,c}-T2 field may exist because the P_{cmax,c}-T1 value is not transmitted when only the PUCCH is transmitted in the Pcell. Accordingly, one P_{cmax,c} field may be configured for the PSC.

Referring back to the step S4900, if, as a result of the determination, the PUSCH and the PUCCH can be transmitted at the same time, the mobile station configures any one of the MAC control elements having the first, the second, the third, and the fourth format at step S4905. If, as a result of the determination, the PUSCH and the PUCCH cannot be transmitted at the same time, however, the mobile station configures any one of the MAC control element having the fifth, the sixth, the seventh, and the eighth format at step S4910.

FIG. 50 is a flowchart illustrating a method of a mobile station transmitting power information according to further yet another example of the present invention.

Referring to FIG. 50, the mobile station calculates a carrier maximum transmission power P_{cmax,c} for each of the CCs belonging to a PRCG at step S5000. A method of calculating the carrier maximum transmission power may be performed according to, for example, Equation 1 to Equation 6. Information about the PRCG may be previously known between the mobile station and a base station, the mobile station may have transmitted the information to the base station separately, or the base station may have informed the mobile station of the information. The carrier maximum transmission power may be represented on the basis of a range mapping table, such as Table 1 to Table 4.

The mobile station determines whether there is an identical power cell group (IPCG) at step S5005. If, as a result of the determination, any CC is determined not to exist in the IPCG, the mobile station determines whether a PSC is included in the PRCG at step S5010. If, as a result of the determination, the PSC is determined to be included in the PRCG, the mobile station configures the MAC control element of the seventh format at step S5015. If, as a result of the determination, the PSC is determined not to be included in the PRCG, the mobile station configures the MAC control element of the eighth format at step S5020.

Referring back to the step S5005, if, as a result of the determination, two or more CCs are determined to belong to the IPCG, the mobile station configures a CIF at step S5025. The CIF has a bitmap form, and the mobile station may configure the CIF by setting a bit value, mapped to each of the CCs, to 1 or 0.

The mobile station determines whether the CC of a PSC belongs to the PRCG at step S5030. This may be determined by determining whether a bit, corresponding to the CC of the PSC has been set as a D field in the CIF. If, as a result of the determination, however, the CC of the PSC is determined not to belong to the PRCG, the mobile station configures the MAC control element of the sixth format at step S5035.

If, as a result of the determination, the CC of the PSC is determined to belong to the PRCG, the mobile station determines whether a CIF regarding the CC of the PSC indicates 1 at step S5040. If, as a result of the determination, the CIF regarding the CC of the PSC is determined to indicate 1, the mobile station configures the MAC control element of the sixth format at step S5035.

If, as a result of the determination, however, the CIF regarding the CC of the PSC is determined to indicate 0, the mobile station configures the MAC control element of the fifth is format at step S5045.

Next, the mobile station transmits the configured MAC control element to a base station at step S5050.

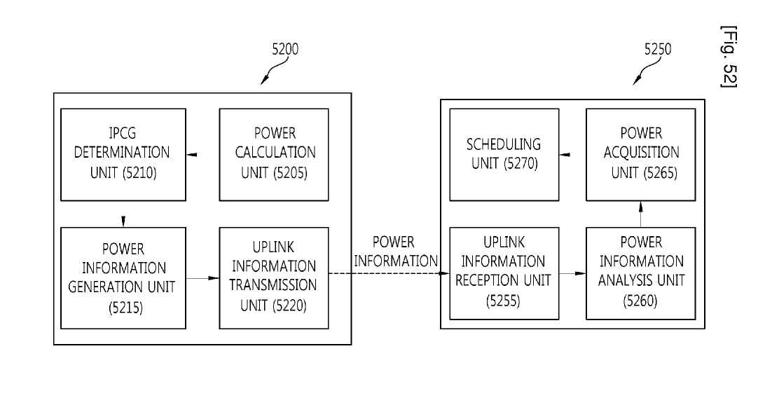

FIG. 51 is a flowchart illustrating a method of a base station receiving power information according to further yet another example of the present invention.

Referring to FIG. 51, the base station receives an MAC control element from a mobile station at step S5100. The base station determines whether there is a CC in an IPCG at step S5105.

If, as a result of the determination, a CC is determined not to exist in the IPCG, the base station determines whether a PSC is included in a PRCG at step S5110. If, as a result of the determination, the PSC is determined to be included in the PRCG, the base station determines the received MAC control elements as the MAC control element of the third format at step S5115. If, as a result of the determination, however, the PSC is determined not to be included in the PRCG, the base station determines the received MAC control elements as the MAC control element of the eighth format at step S5120.

If, as a result of the determination, at least one CC is determined to exist in the IPCG, the base station determines whether a CIF for the CC of a PSC has been set as a D field at step S5125.

If, as a result of the determination, the CIF for the CC of the PSC is determined to have been set as the D field, the base station determines the received MAC control element as the MAC control element of the sixth format at step S5130. If, as a result of the determination, however, the CIF for the CC of the PSC is determined not to have been set as the D field, the base station determines whether the CIF for the CC of the PSC is 1 at step S5135.

If, as a result of the determination, the CIF for the CC of the PSC is determined to be 1, the base station determines the received MAC control element as the MAC control element of the sixth format at step S5130. If, as a result of the determination, the CIF for the CC of the PSC is determined to be 0, the base station determines the received MAC control element as the MAC control element of the fifth format at step S5140.

The base station obtains a carrier maximum transmission power value for the CC belonging to the PRCG by successfully interpreting the received MAC control element at step S5145.

FIG. 52 is a block diagram of a mobile station transmitting power information and of a base station receiving the power information according to an example of the present invention.

Referring to FIG. 52, the mobile station 5200 includes a power calculation unit 5205, an IPCG determination unit 5210, a power information generation unit 5215, and an uplink information transmission unit 5220.

The power calculation unit 5205 calculates power headroom or a carrier maximum transmission power for a CC.

The IPCG determination unit 5210 may compare the carrier maximum transmission powers of CCs and determine CCs, having the same carrier maximum transmission power, or CCs whose difference between the carrier maximum transmission powers is a critical value or less as an IPCG. Furthermore, the IPCG determination unit 5210 determines whether a type 1 maximum transmission power and a type 2 maximum transmission power regarding the CCs of a PSC are identical with each other.

The power information generation unit 5215 represents the carrier maximum is transmission power for each CC or the representative maximum transmission power of the IPCG on the basis of Table 1 to Table 4. Furthermore, the power information generation unit 5215 generates power information using a method, such as that described with reference to FIGS. 9 to 39.

For example, the power information generation unit 5215 may set a TIF by determining whether the type 1 maximum transmission power and the type 2 maximum transmission power are identical with each other.

Meanwhile, the power information generation unit 5215 determines whether a carrier maximum transmission power field regarding the CC of the PSC will be set as any one of a P_{cmax,c}-T1 field, a P_{cmax,c}-T2 field, and a P_{cmax,c}-T field. This is determined according to an association between the TIF and the bit value of the CIF of the PSC as in Table 7 or Table 8.

The power information generation unit 5215 sets a CIF with reference to the IPCG. Each bit of the CIF is mapped to one cell of the PRCG, and the value of the bit indicates whether the cell belongs to the IPCG. In other words, if the bit value is ‘1’, it means that the cell belongs to the IPCG. If the bit value is ‘0’, it means that the cell does not belong to the IPCG.

The power information generation unit 5215 determines a P_{cmax,c}-G field and a P_{cmax,c}-P1 field, . . . , a P_{cmax,c}-Pn field on the basis of the CIF.

Consequently, the power information generation unit 5215 generates power information, including the CIF, the TIF, and at least one carrier maximum transmission power field.

The power information may be higher layer signaling, such as an MAC message or an RRC message or may be physical layer signaling. The power information may also refer to an MAC control element for a power report. In some embodiments, the power information is may refer to an MAC control element for, in particular, a carrier maximum transmission power report. In some embodiments, the power information may refer to both an MAC control element for a PHR and an MAC control element for a carrier maximum transmission power report. In some embodiments, the power information may refer to a carrier maximum transmission power field.

The uplink information transmission unit 5220 transmits the power information to the base station 5250.

The base station 5250 includes an uplink information reception unit 5255, a power information analysis unit 5260, a power acquisition unit 5265, and a scheduling unit 5270.

The uplink information reception unit 5255 receives the power information from the mobile station 5200.

The power information analysis unit 5260 analyzes the power information on the basis of the examples described with reference to FIG. 48 or FIG. 51. For example, the power information analysis unit 5260 may analyze the type and number of at least one power field on the basis of an association between the TIF or the CIF or both. The at least one power field include at least one of a P_{cmax,c}-T1 field, a P_{cmax,c}-T2 field, a P_{cmax,c}-T field, a P_{cmax,c}-G field, and a P_{cmax,c}-P field.

The power acquisition unit 5265 extracts a carrier maximum transmission power field on the basis of the result analyzed by the power information analysis unit 5260 and calculates a carrier maximum transmission power value for each CC on the basis of the carrier maximum transmission power field.

The scheduling unit 5270 performs uplink scheduling on the basis of the carrier maximum transmission power value for each CC and generates an uplink grant.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not restricted by the embodiments, but should be interpreted on the basis of the following claims. Accordingly, all technical spirits within an equivalent range should be interpreted as being included in the scope of the present invention.

1. A method of a mobile station transmitting power information in a multiple component carrier system, the method comprising:
calculating a maximum transmission power which can be outputted, for each of a plurality of component carriers;
configuring a Cell Indicator Field (CIF) to indicate component carriers having an identical maximum transmission power;
configuring a first power field to indicate the identical maximum transmission power;
generating a Medium Access Control (MAC) message, comprising the CIF and the first power field; and
transmitting the MAC message to a base station,
wherein the MAC message comprises an MAC sub-header and an MAC control element, and
the MAC sub-header comprises a Logical Channel Identifier (LCID) field to identify that the MAC control element is an MAC control element for a power report of one or more component carriers.

2. The method of claim 1, wherein the MAC message further comprises a second power field to indicate any one of a first type of a maximum transmission power when only a Physical Uplink Shared CHannel (PUSCH) is transmitted and a second type of a maximum transmission power when both a PUSCH and a Physical Uplink Control Channel (PUCCH) are transmitted.

3. The method of claim 1, wherein the MAC message further comprises a third power field to indicate a maximum transmission power for component carriers having a maximum transmission power different from the identical maximum transmission power which the first power field indicates.

4. The method of claim 1, wherein the MAC control element is an integer multiple of an octet having an 8-bit length.

5. The method of claim 1, wherein the MAC control element comprises the CIF and the first power field.

6. A mobile station for transmitting power information in a multiple component carrier system, comprising:
a power calculation unit for calculating a maximum transmission power which can be outputted for each of a plurality of component carriers;
an Identical Power Cell Group (IPCG) determination unit for determining a group having component carriers an identical maximum transmission power;
a power information generation unit for generating a Medium Access Control (MAC) message, including a Cell Indicator Field (CIF) to indicate the component carriers included in the group and a first power field to indicate the identical maximum transmission power; and
an uplink information transmission unit for transmitting the MAC message to a base station,
wherein the power information generation unit generates the MAC message comprising a MAC sub-header and a MAC control element, and
the MAC sub-header comprises a Logical Channel Identifier (LCID) field to identify that the MAC control element is an MAC control element for a power report of one or more component carriers.

7. The mobile station of claim 6, wherein the MAC message further comprises a second power field to indicate any one of a first type of a maximum transmission power when only a Physical Uplink Shared CHannel (PUSCH) is transmitted and a second type of a maximum transmission power when both a PUSCH and a Physical Uplink Control Channel (PUCCH) are transmitted.

8. The mobile station of claim 6, wherein the MAC message further comprises a third power field to indicate a maximum transmission power for component carriers having a maximum transmission power different from the identical maximum transmission power which the first power field indicates.

9. The mobile station of claim 6, wherein the MAC control element is an integer multiple of an octet having an 8-bit length.

10. The mobile station of claim 6, wherein the MAC control element comprises the CIF and the first power field.

11. A method of a base station receiving power information in a multiple component carrier system, the method comprising:
receiving a Medium Access Control (MAC) message, comprising a Cell Indicator Field (CIF) to indicate component carriers having an identical maximum transmission power and a first power field to indicate the identical maximum transmission power, from a mobile station;
checking an Identical Power Cell Group (IPCG) based on the CIF and obtaining a maximum transmission power value for each of the component carriers based on the IPCG and the first power field; and
performing uplink scheduling based on the maximum transmission power value for each of the component carriers,
wherein the MAC message comprises a MAC sub-header and a MAC control element, and
the MAC sub-header comprises a Logical Channel Identifier (LCID) field to identify that the MAC control element is an MAC control element for a power report, of one or more component carriers.

12. The method of claim 11, wherein the MAC message further comprises a second power field to indicate any one of a first type of a maximum transmission power when only a Physical Uplink Shared CHannel (PUSCH) is transmitted and a second type of a maximum transmission power when both a PUSCH and a Physical Uplink Control Channel (PUCCH) are transmitted.

13. The method of claim 11, wherein the MAC message further comprises a third power field to indicate a maximum transmission power for component carriers having a maximum transmission power different from the identical maximum transmission power which the first power field indicates.

14. The method of claim 11, wherein the MAC control element is an integer multiple of an octet having an 8-bit length.

15. The method of claim 11, wherein the MAC control element comprises the CIF and the first power field.

16. A base station for receiving power information in a multiple component carrier system, comprising:
an uplink information reception unit for receiving a Medium Access Control (MAC) message, comprising a Cell Indicator Field (CIF) to indicate component carriers having an identical maximum transmission power and a first power field to indicate the identical maximum transmission power, from a mobile station;
a power information analysis unit for checking an Identical Power Cell Group (IPCG) based on the CIF;
a power acquisition unit for obtaining a maximum transmission power value for each of the component carriers based on the IPCG and the first power field; and
a scheduling unit for performing uplink scheduling based on the maximum transmission power value for each of the component carriers,
wherein the MAC message comprises a MAC sub-header and a MAC control element, and
the MAC sub-header comprises a Logical Channel Identifier (LCID) field to identify that the MAC control element is an MAC control element for a power report, of one or more component carriers.

17. The base station of claim 16, wherein the MAC message further comprises a second power field to indicate any one of a first type of a maximum transmission power when only a Physical Uplink Shared CHannel (PUSCH) is transmitted and a second type of a maximum transmission power when both a PUSCH and a Physical Uplink Control Channel (PUCCH) are transmitted.

18. The base station of claim 16, wherein the MAC message further comprises a third power field to indicate a maximum transmission power for component carriers having a maximum transmission power different from the identical maximum transmission power which the first power field indicates.

19. The base station of claim 16, wherein the MAC control element is an integer multiple of an octet having an 8-bit length.

20. The base station of claim 16, wherein the MAC control element comprises the CIF and the first power field.
